(19) United States
(12) Patent Application Publication
(10) Pub. No.: US 2004/0024846 A1
(43) Pub. Date: Feb. 5, 2004

(54) Method of enabling a wireless information device to access data services

(76) Inventors: Stephen Randall, London (GB); John Matthew Forsyth, London (GB)

Correspondence Address: Richard C Woodbridge, Woodbridge & Associates, P O Box 592, Princeton, NJ, 08542-0592, US

(21) Appl. No.: 10/362,109

(22) PCT Filed: Aug. 22, 2001
(86) PCT No.: PCT/GB01/03788

(30) Foreign Application Priority Data
Aug. 22, 2000 (GB) 0020735.7
May 2, 2001 (GB) 0110780.4

(51) Int. Cl. G06F 15/16

(52) U.S. Cl. 709/219

(57) ABSTRACT

A method of enabling a wireless information device to access data from several data services providers in which the method comprises the step of the device using an extensible framework which handles data passing to and from several applications resident on the device, the framework being shared by each of the applications resident on the device and also being shared by each of the data services providers.

### BACKGROUND OF THE INVENTION

1. Field of the Invention

This invention relates to a method of enabling a wireless information device to access data services, particularly from several data services providers. The term ‘wireless information device’ used in this patent specification should be expansively construed to cover any kind of device with one or two way wireless information capabilities and includes without limitation radio telephones, smart phones, communicators, personal computers, computers and application specific devices. It includes devices able to communicate in any manner over any kind of network, such as GSM or UMTS, CDMA and WCDMA mobile radio, Bluetooth, IrDA etc. A data service provider is an entity which supplies information of interest to a user, the term encompasses commercial entities, as well as individuals.

2. Description of the Prior Art

The convergence of communications and computing is delivering a new generation of wireless information devices, often referred to as smart phones or communicators. The most capable of these devices utilise operating systems and related applications such as the Symbian platform from Symbian Limited of the United Kingdom. Wireless information devices based on the Symbian platform, are ‘smarter’ than current generation GSM phones in being able to offer multiple, advanced, robust client based applications. For example, current designs of communicators based on the Symbian platform include all of the applications found on a fully featured PDA, such as a contacts manager, messaging application, word processor, spreadsheet, synchronisation etc.

One difficulty faced by designers of wireless information devices is how to effectively allow a user to obtain data from data service providers (e.g. commercial organisations who can supply news, sport, weather, shopping information, location information—in essence any data which users are willing to pay for.). One common approach in WAP enabled mobile telephones is to use a micro-browser to access a WAP portal with links to various sites of interest; another is to use a search engine (e.g. Google.com). But each of these PC based approaches fails to transfer effectively to wireless information devices. There are three main reasons for this. First, the small screen size in, for example, a WAP enabled mobile telephone, is such that using a micro-browser can be difficult for many people. Secondly, experience shows that the non-computer literate users of mobile telephones find using a portal and also a search engine inherently difficult Thirdly, the small screen size and lack of computer skills makes it unlikely that a user will follow multiple hyperlinks or scroll though multiple windows to find the information they need. Yet without a compelling and simple approach to allowing people to find the information they need, they are unlikely to be willing to pay money to obtain data. Since 3G systems are commercially based on the premise of users paying to obtain data, this is a serious problem.

### SUMMARY OF THE PRESENT INVENTION

In a first aspect there is provided a method of enabling a wireless information device to access data from several data services providers in which the method comprises the step of the device using an extensible framework which handles data passing to and from several applications resident on the device, the framework being shared by each of the applications resident on the device and also being shared by each of the data services provider.

The present invention therefore moves away from the conventional model of the internet browser as being the sole application which displays on the user's device information from data services providers. Instead, it proposes that multiple applications on the device (although clearly not all applications on the device) can each receive data from multiple data services providers. The consequences and advantages are described below.

The framework may comprise standardised APIs presented by several applications resident on the wireless information device to data services components, also resident on the wireless information device (or which can be loaded onto or plugged-into the device). These components allow each application to obtain and display data provided by commercial data service providers. The APIs may share common elements, leading to significant code savings, a major advantage in a wireless information device with limited resources.

A data services component can provide new functionality to more than one application resident on the wireless information device and will typically be a plug-in. Coupling an application (e.g. a calendar application) with a component which provides a mechanism and pathway for data services for that application and any other with which it is compatible has not been done before and leads to several advantages. For example, a directory application (which contains a user's contacts list, and is capable of acting as a directory for any other name/contact data), a location application (which gives a user's location and includes digital maps) and a shopping application (which allows a user to pay for purchases using the wireless information device) might all be resident on a device; each present a common set of APIs. A Yellow Pages™ data services plug-in is downloaded off air and is accessed by each of these applications, although in different ways. The Yellow Pages plug-in allows different services to be located through the directory application; for example, a search request performed in the directory application (e.g. search: ‘cameras’) could be routed to a Yellow Pages remote server, which responds with the required data, including detailed maps in the location application; special shopping offers are be pushed into the shopping application; nearby shops/services are shown in the location application. The Yellow Pages data services provider may charge a fee per hit to each shop etc. featured in a user's search and a further fee if an e-commerce transaction results from the query. An Amazon™ plug-in could integrate into a calendar and a shopping application, giving daily special offers and information on when books etc have been dispatched to the calendar and allowing shopping via the Amazon site etc. This would also allow Amazon functionality (e.g. ‘Find books on this topic’) to be accessed in various applications—e.g. when reading a newspaper in a News application, or reading e-mail in an e-mail client Another example would be a digital rights management plug-in which could work with (a) a digital music player for compressed audio (e.g. mp3 format) and (b) a conventional CD audio format player and (c) a still image manipulation program (e.g. Photoshop) and (d) a digital video player. Data from multiple sources could be subject to the DRM technique or techniques supported by the plug-in and be available to the device.

The APIs may be extensible, with extensions conforming to a common standard so that new functions offered by a component are defined by certain new APIs; these APIs can then be re-used whenever the same new functionality has to be offered by a different application. A new data service can be readily written since there is a common, standardised set of APIs; once loaded onto a device, the device simply has to work out which existing, resident applications can use the features offered by the new service.

Data component plug-ins can be dynamically added as a user moves into new locations—e.g. in an airport, there could be a flight schedule plug-in, which automatically loads (subject to user consent) when the user is in or close to the airport, generating an icon in the user's calendar application. When selected, the user can locate flight details and these will subsequently appear, regularly updated, in the user's calendar entry—with, for example, ‘Proceed to Gate 3’ at occurring at the relevant time with an alarm.

Another feature of an implementation is that data sent from a commercial data service provider can automatically populate one or more applications (such as PIM applications) on the wireless information device. Because the data goes automatically into an application on a user's wireless information device, where it is likely to be looked at and found useful, this approach overcomes the drawback with the browsing model—(a) people give up before they find the information of interest because navigating to it takes too many clicks and (b) browsing on a small screen device is difficult. Instead, getting the right data becomes fast and convenient. For example, sporting fixtures and entertainment listings could be transmitted from a data service provider placed straight into a user's calendar application, with the entries being listed at the applicable times and dates; the user could click on these for more information and to perform e-commerce actions (e.g. buy tickets). News headlines and weather could be sent straight into a user's calendar application too (with perhaps only today's news visible). Hence, if one subscribes to a BBC™ data service, one could get current news sent straight into one's calendar or indeed any other user specified application. Headlines could be provided free and pushed into an appropriate application; if the user wished to obtain more detailed information on a particular headline, then it could select that headline, which would cause an information request to be sent to a BBC server, which would then supply more detailed information, possibly with an associated fee (either per item, or on a subscription basis).

A combined data push and data pull model is therefore envisaged, with pushed data being free and delivered to the device for automatic display in an appropriate application (and not just a generic browser) and giving links which if selected allowing the user to pull related enriched data from external sources with an associated fee.

Some further example are that bills could go straight into a calendar application on the day received or date payment is due and also go into an electronic banking application, which stores account balances and is able to issue secure payment instructions. Bills can then readily be paid, with the instruction to pay going to a user's bank from the banking application. In a digital radio application, a message ‘Buy the CD now?’ could accompany a song (e.g. appearing in the digital radio application user interface); if selected, the banking application could sanction automatic payment and send a request to a CD fulfilment house (e.g. Amazon™).

The data sent from a data service provider may be a data object, such as an object which conforms to or is an extension of the Smart Message standard supported by Nokia Mobile Phones Limited of Finland. The data may be transported over the SyncML, IrMC or OBEX wireless transport standards. SOAP (Simple Object Access Protocol) may be used by the client device to pull information relating to a data object; for example, SOAP calls may be included in the data object itself. These data objects are typically signed to enable authentication to occur. Another feature is that data objects pushed to a wireless information device can be shared with others, who can also then request (i.e. pull) further information from a data service provider using that data object, giving the data objects a viral quality.

The extensible framework may be defined by a schema. Hence, in another aspect, there is a method of enabling a wireless information device to access data from several data service providers in which the method comprises the step of each of several applications resident on the device using at least in part a common, extensible schema which:

(a) defines objects from each of the data service providers; and

(b) permits each data service provider to define a new object with additional attributes, in which the new object can be used by any such application on the device to the extent that the attributes of the new object are recognisable by that application.

The objects are typically sent by commercial data providers and interface to client resident applications using standardised APIs. The term ‘schema’ covers any consistent description of data, including data in a database (such as the extensible database described more fully in sections D-I Detailed Description) and data in an object (such as the objects described more fully in section C Detailed Description which are handled by the data component plug-ins).

In many prior art systems, hard-coded data structures are typically used and not flexible schemas. Hence, extending such an infrastructure typically requires either a proprietary extension by one software company, which other companies may not be able to interpret correctly, or else a consensus re-writing of the hard-coded data structures, which can be slow to achieve. With the present invention, a data service provider can choose to enhance an object with additional fields or attributes; because these are defined in a schema (which term includes a DTD—Document Type Definition) which accompanies the object, any application capable of using the additional fields or attributes can make immediate, fill use of the enhanced objects. An application which cannot make use of the enhanced object, is simply unaffected by the enhancements. A data service provider can, perhaps responding to consumer suggestions, enhance an existing object with new attributes; the user can then download the enhancements to applications resident on its device, or entirely new applications, which are needed to make full use of the enhanced objects.

As an example, take the object to be information relating to an individual and held on an extensible framework which is a database defined by a schema (Table 1 gives an example of this). As new fields are thought of, the object can be readily extended. Hence, a user might choose to subscribe to a service which allowed others to track his or her location—location could be a new attribute. The user's friends or parents etc who wish to track the users location might initially have applications resident on their devices which allow them to see the user's current telephone number and address perhaps integrated into a contacts application). Once the user has subscribed to the location service, then the friends/parents could add a ‘map’ application to their own devices, which could show their position on digital maps and also, by using the location attribute of the user's data object, it could also show the position of the user. Objects can have many different attributes, although primarily it is likely that core attributes will fall under the general headings of personal information, time based information and location based information. As such, they can be handled by contacts, calendar and map type applications. Many extensions beyond this core categorisation are possible; a strength of the present invention is that it can readily accommodate them as and when they are conceived. Hence, the present invention is flexible and extensible in a way that prior art systems cannot achieve.

The objects may be pushed from a data service provider to a device; the object may be limited in the attributes initially used by the device, for example, the device may use only those attributes which allow it to display an icon or other shorthand (e.g. name/title) correctly in the applicable application(s). But when a user selects the icon or shorthand, additional options derived from other attributes of the object may be made visible. For example, a weather object may initially just display on a device as a ‘sun’ symbol (or other symbol relevant to the local weather conditions at the device location) in the calendar application open at today's date. If the sun icon is selected by a user, additional options are displayed (e.g. pollen count, CO2 levels etc.); these are derived from further attributes of the object. When a user selects one of these options, a link to the network could be initiated to pull down the required additional information; a fee could be levied for this. In this way, the present invention allows users to rapidly access information of relevance to them and provides a straightforward charging model, based on free, pushed data displayed in relevant applications (and not just a generic browser) and charged-for, pulled data to enrich the free, pushed data.

The objects may be enhanced with additional attributes only once a user has paid a fee or subscription; since the objects can be sent between users, some form of access control/digital rights management systems may need to be invoked to ensure that access to enriched data is only provided to those entitled.

The objects may contain attributes at different levels of granularity—for example, location might be defined in very approximate terms without charge; it may be no better than a given city. But a user might be able to obtain more precise information by paying more—so a location attribute could include not simply the name of the city in which a person was based, but also a call (such as a SOAP call) to be used by a client if it wishes to pull in enriched location information, perhaps from a service which can track the location of users to within a few meters.

A further feature is that all directory/contacts type applications in a wireless information device may be grouped together, a single search can then be conducted across all directory/contacts type applications to unify the experience of looking up names and finding things. A search or other data service request can use additional information derived from an application currently in use the wireless information device to provide additional search or request criteria. A browser based search could in theory also do this, but building links into other applications in the browser is difficult. But in the present invention, the linkage is inherent because the data components work across multiple applications.

Various specific implementations of the invention and additional aspects are further particuarised in the claims.

### DETAILED DESCRIPTION

A. Overview of the ADS System

The present invention will be described with reference to an implementation from Symbian Limited of London, United Kingdom. This implementation is called the ADS™ system. The ADS system addresses the pervasive requirement for wireless applications to access and share information: the ADS system is an ‘information distribution architecture’, optimised for wireless computing, offering an extensible framework for the fast and efficient design, build and roll-out of applications which need to securely and reliably access and share information. The ADS system's flexible and extensible architecture supports a potentially unlimited set of these kinds of client-based wireless applications. The term ‘information distribution architecture’ should be broadly construed to cover any system which enables information (including voice, text data, video etc.) to pass between entities.

The core structures of the ADS system information distribution architecture are (a) internet servers hosting extensible databases; (b) wireless information devices which can access information on these databases; and (c) applications resident on these devices which present a common set of APIs to plug-ins from commercial service providers. Hence, three modes of data access are possible in ADS:

1. An application resident on the device queries and receives data from the remote, extensible database. No plug-in components are used and the application is stand alone.

2. An application resident on the device uses a plug-in to receive data from a commercial service provider, but the service provider does not use the extensible database, but a conventional, dedicated server.

3. A combination of the two above: an application resident on the device uses a plug-in to receive data from a commercial service provider and that data service provider uses the extensible database.

The present invention focuses on options 2 and 3. But for completeness, a complete ADS description is provided. Because of this quite complex structure, the Detailed Description of this specification is organised as follows:

Section A: Overview of the ADS system

Section B: The ADS System—core advantages

Section C: Client side aspects: data plug-ins which work across multiple applications to allow data services to be delivered directly into applications

Section D: Identities—user interaction aspects

Section E: Shared content—user interaction aspects

Section F: ADS—server side aspects—general comments on the enabling technology

Section G: ADS—server side architecture—ServML

Section H: An illustration—how the ADS System framework is used in making a telephone call

Section I: An illustration—the ADS system database

Section J: New services and functions

Appendix 1: More new services and functions

In more depth, the ADS system includes the following:

(a) internet servers hosting extensible databases with attributes remotely extensible by application authors using a standard protocol over a network. The database contains information from or relating to many different entities; it is organised into information fields which an entity can complete or have completed. Table 1 (Section 1) includes examples of the kinds of information fields which are possible for an individual. Information is placed onto the database by an entity so that it can be readily shared with other entities: the database in effect represents a web page containing information specific to that entity. The information on the database can be thought of as a ‘master’ version of information. The database can be readily extended to include new tagged fields relevant to new applications.

The database can define which entities can read different fields: Alice can therefore give Bob rights to read only certain fields in her database.

(b) wireless information devices running applications which access data by interacting with data component plug-ins supplied by commercial data services providers using a standardised set of APIs to access data Data may be (but does note have to) come from the extensible databases.

(c) wireless information devices running applications which access the information held on the extensible databases running on central servers and other wireless information devices without the plug-ins described above. A wireless information device (as well as web browsers) can access an entity's database by sending to the server an unchanging pointer or key (an ‘ADS Number’) which is unique to that entity. The ADS number may include more attributes than just a number, further, an individual entity cold have multiple AADS numbers, each appropriate for a different circumstance. ADS numbers are typically constructed using text strings and can be though of as defining a namespace. When Bob's device sends Alice's ADS Number to the server, then the server recognises Bob's device and allows that device to read Alice's information held on the database which is specified as being accessible to Bob. The ADS system is an extensible framework which offers secure and persistent entity to entity information distribution. Each of these key terms can be expanded on as follows:

Extensible—The ADS systems is designed so that new data service functionality can be dynamically added to existing client resident applications using data component plug-ins. The ADS system is also designed so that a new application can be created on a wireless information device with no new server-side application by remote application authors using a standard protocol to extend the database fields or (equivalently) attributes. All that is needed is for the database (on the remote server or client resident) to be expandable to accommodate the new fields (if any) required by the new application and for the new application to be able to extract information from the required fields in the database. XML tags conforming to a standardised schema can be used to facilitate this.

Framework—The ADS system is a general purpose architecture which can be used by many different applications which require information sharing; it is in essence a framework.

Secure—As noted above, the ADS system allows signed data objects to be directly inserted into a user's device resident application; the data object can therefore be fully authenticated using an automated process. In ADS, a user can also specify the remote database access rights given to different people or groups: an arbitrary group of entities may be stored as an attribute which gives access permissions to data in the database. The ADS system includes additional access control mechanisms, such as checking the identity of the calling device at the server or the called device and assessing the access rights appropriate to that device. This protection is extended to the voice call mechanism, providing a flexible call-screening methodology.

Persistent—As also noted above, the framework borrows the concept of the computer software pointer. Consider Alice, who is publishing some information, and Bob who is accessing it. Usually Bob would store a local copy of the information on his device, and this data would atrophy as time went by. Using the ADS system, Alice stores her data on a server on the Internet, and Bob merely stores a pointer to that data or a local copy of that data (or a subset of it) in conjunction with the pointer. Then as Alice changes her data, Bob's view of it can readily remain up-to-date as (i) the new data can be automatically pushed to Bob or (ii) Bob can pull the new data into his device whenever he needs to make sure that any local copy he may have is up to date.

Entity to Entity—since the framework contains an indirection mechanism, it can be used to link two entities, and not merely 2 devices. Via a variety of mechanisms (programming by the owner, time and location information, information on device currently in use) the server transparently decides which device an entity should be contacted on at any particular time.

B. The ADS System: Core Advantages

Core Advantage 1: Extensible Framework

There is currently no common infrastructure for wireless information devices which can be used by applications for information distribution. Consequently, data applications for wireless information devices have to be built using bespoke solutions, often causing them to be slow to market costly and complex. The ADS system offers an extensible framework for the fast and efficient design, build and roll-out of client-based applications which involve an element of secure and reliable information distribution. ADS provides the common, data infrastructure for wireless information exchange.

Core Advantage 2: Reliable Entity to Entity Communications

One important example of the class of applications which require information distribution is entity to entity communication via mobile clients over wireless networks. The ADS system allows entity to entity communication which is reliable Currently, the contact information on a typical user's PDA or PIM will contain significant amounts of out of date information, with the remainder atrophying in a non-transparent way. Hence, communication using such information is inherently unreliable. Yet further, the burden of adding and maintaining contacts using many conventional systems is considerable, so that even up to date contact information can too easily not be entered into a user's PDA or PIM. ADS exemplifies a reliable communications system in that a communication channel can be opened even if the called entity, Alice, has changed her telephone number and has failed to notify the calling entity, Bob. But unlike other proposed solutions to the problem of enabling reliable communication, the ADS system is not directed merely to person to person communication, but acknowledges and accommodates the reality that whilst much commercial communication is between persons (i.e. individuals), those persons are communicating on behalf of a larger entity, such as an employer. Hence, the ADS system enables entity to entity communications, where the term entity embraces not only individuals, but also companies, organisations, and positions within an organisation (e.g. vice president, sales etc), and devices which may be associated with any entity.

ADS adds further to its inherent reliability by introducing the concept of indicating the freshness of data. This can be implemented through a date stamp indicating when particular data was obtained from the server, or a graphical icon representative of freshness. For example, if Alice updates her contact information on her device, that device informs Alice's server, which in turn informs Bob's server (if we are dealing with a multiple server implementation). Bob's server might then do one of several things. It could send a SMS or similar to Bob's device stating that Alice's information was out of date and asking him if he wants to refresh it. Less obtrusively it could send a SMS to Bob's device which would result in an ‘Out of Date’ message or ‘data staleness’ icon appearing next to Alice's contact information when Bob chooses to view that information. Alternatively, it could actually update Bob's device with Alice's new information. Each option would impose a different band of useage and Bob might therefore be charged differentially depending on which option he chooses.

Core Advantage 3: Client Device Centric

The ADS system also advances over existing systems by accommodating the trend for wireless information devices to be an important repository of personal information (e.g. contact information, diary information etc.). The ADS system provides a mechanism for the often considerable and valuable amounts of information on these personal devices to be kept up to date, without imposing a significant data input or up-dating burden on their owners. In the ADS system, local copies of the master information held on the central server(s) can be automatically created and maintained up to date. The ADS system signifier of data freshness (noted in Core Advantage 2 above)—a visual indication of how recently any locally stored data was obtained and how ‘fresh’ or reliable that data is—is also an important attribute to an effective client-centric approach. Certain user defined fields can be exempted from automatic server updating, allowing a user to preserve information as required.

Earlier workers, such as the Stanford MPA team and the designers of the numerous web based PIMs, have treated the personal wireless information device as a mere conduit to information, rather than as an important information repository in its own right and as a consequence require a mobile phone to invariably contact a central server as part of a voice call process. But for many kinds of information it is very useful to be able to store on a client wireless information device information relating to another entity, such as contact numbers, since doing so removes the need for the wireless information device to invariably poll a central resource to obtain an up-to date contact number prior to initiating a call. Instead a call can be initiated using the number stored on the wireless information device; only where that number proves incorrect, is the central server accessed for the correct number. This approach significantly reduces network traffic and client device operations.

Further, ADS envisages commercial data service providers pushing relevant data (typically Smart Message data objects) straight into appropriate parts of a user's existing applications (e.g. TV listings pushed from a news provider straight into a calendar application, so that a user can read them whilst in the calendar application and possibly even use the device as a remote controller or to programme a video recorder). This reduces and may eliminate the need for the user to browse (typically with a less than effective micro-browser) the internet. It acts in effect like a fully personalised web portal, yet with the information links not consolidated in one general area, but instead distributed to the domains in which they are most likely to be relevant to a user. A user can select a data object to obtain more detailed information, or initiate other functions, such as an e-commerce transaction.

Core Advantage 4: Fable and Robust Access Control

As noted above, the ADS system is fundamentally an information distribution mechanism. Access control is therefore a central requirement, which the ADS system implements through an easily operated security mechanism which allows a user to define which entities have read/write access to any given field in a database of information relevant to that entity (e.g. which entities can see a home contact telephone number etc.).

Authentication (i.e. identifying an entity seeking information) can be achieved through the server recognising Bob's device and determining the database access rights which Alice has given him. Recognising Bob's device can be achieved in several ways; for example, Bob's device could have a unique, secret ID number which it transmits to the server; the server could be programmed to authenticate Bob only where the transmitted and secret ID was recognised by it. Likewise, the unique but not secret caller line ID could be used as a lower or supplemental authentication check. This form of data transfer could be via SMS or packet delivery in packet based systems. If the caller Bob also has stored on the server his own personal information, then a far higher level of authentication can readily take place, with caller Bob (as opposed merely to Bob's device) being authenticated by being asked by the server to state answers to personal information questions or select answers from a multiple choice (e.g. a PIN, or, more memorably, select your favourite colour/restaurant/recent film etc.), with the server only authenticating Bob when he answers correctly. Authentication of Bob the person, rather than Bob's device, is relevant not only where a high level security is needed but also where Bob borrows someone else's wireless information device or uses a public device (unless Bob is able to personalise a temporary device by placing his own SIM card etc. into it). Once authenticated, the server passes to Bob's device the information it requests. That is typically done by Bob's device sending various data tags defining its enquiry and the server responding with the relevant information.

The access control methods described above relate to controlling access to information on the server. But as noted earlier, the ADS system also supports information exchange directly between wireless information devices, which therefore also requires some forms of access control. There are many situations where Bob does not need information on the server as such, but instead needs to communicate directly (peer to peer) with Alice. For example, Bob may wish to have a voice conversation with Alice. In this scenario, Bob can call Alice directly. Authentication of Bob's calling device is performed not by the server, but by Alice's device. For example, Alice's device may allow the call if Bob's device has a recognised unique ID or caller line ID, namely one which is stored locally on Alice's device. If Bob calls Alice using a private telephone number which Alice only gives out to her close friends, then that may itself be sufficient authentication.

Since Alice's wireless information device typically includes a cached version of all of her information which is on the central server, it remains possible for Bob's device to communicate directly with Alice's device without a prior exchange with the server in order to read her information. Generally, Alice would prefer Bob's data requests to be routed to the server, rather than utilise the limited resources of her wireless information device. But there are situations where that does not necessarily apply: for example, as is shown in Table 1 (Section I), Alice can post a statement describing her mood; Bob can read that directly from her wireless information device. Additionally, Alice can post the subject of a telephone call she wishes to make to Bob (in Table 1; the subject is “Dinner tonight”) into her wireless information device. When she calls Bob, that subject line appears on Bob's wireless information device before Bob answers the call, giving Bob an indication of what Alice is calling him about. Alice's device directly transfers this data to Bob using an appropriate mechanism (such as SMS or IPv6 data packet) without any server intervention. Information transfer which is direct between mobile phones and does not involve a prior call to the server is appropriate where a connection is being opened up between those devices anyway to support a voice call.

Access rights can be associated with individual entities, and can also be associated with groups of entities. For example, one could categorise one's business contacts into a single ‘Business Contacts’ class, and then associate certain common access rights to all members of that class.

Overall, the ADS system offers a mechanism whereby confidential information can be securely maintained on a server, yet access allowed to those with appropriate permissions using a variety of different authentication mechanisms, all of which are easy to operate yet robust. As information distribution becomes a core inter-entity activity, the importance of establishing wireless information devices as trusted tools will become increasingly apparent The ADS system provides a solid justification for that trust.

Core Advantage 5: Legacy Compatible

Telephone numbers have been fundamental to wireless person to person communication for many years; the ADS system builds upon the familiarity, pervasiveness and usual reliability of the telephone numbering system and does not seek to eliminate it. Hence, users of ADS system wireless information devices will still primarily use famliar (but potentially not persistent) telephone numbers to make voice contact other telephone users, utilising persistent ADS Numbers only where the features and benefits of the ADS system are required (e.g. the called party's telephone number has changed). In one implementation, ADS Numbers are invisible to users: if Bob is given Alice's ordinary telephone number, but Alice is an ADS system user, then Bob can use the ordinary number to access a web database which can download Alice's ADS Number directly to Bob's device.

ADS Numbers will therefore supplement the telephone numbering system, offering the additional core advantages listed above. Hence, the ADS system architecture has been designed not to confront and replace the existing, familiar telephone number systems, but to work alongside it. The ADS system mobile phones will co-exist with conventional mobile phones, whilst offering enhanced functions.

Secti n C

ADS: Client Side Aspects—Data Plug-Ins which Work Across Multiple Applications to Allow Data Services to be Delivered Directly into Applicable Applications

This section briefly describes the aims of some client side aspects of ADS, and gives examples of the sorts of scenarios it can enable. These scenarios challenge the prevailing belief in the industry that ‘nobody knows what services will be popular, so the best thing is to build for flexibility’. This means, normally, assuming services will be accessed through the browser, but the consequence of this is rigidity—‘one size fits none’. The main aims of the ADS project are to:

A. Explore the idea that we can anticipate many of the types of services that will be useful to users and build the infrastructure necessary to support those.

B. Propose a framework for these classes of service that enables a user experience more suited to each type; a framework into which new services can be added.

C. Create this ‘framework of frameworks’ such that services are tightly integrated in a way that the traditional browser model does not allow. So that, for example, theatre listings services are available from a calendar context, and all directory services (Vodafone™ directory enquiries, Yellow Pages™, personal address book) are available from a centralised location.

In ADS, there is far less of a distinction between services and ‘local applications’, and there is certainly not one paradigm of use for accessing data services and one for using local applications. For example, in the traditional model, data services offering directory capabilities, such as a corporate address book or Yellow Pages, would be accessed via an entirely different route from the user's own on-device personal address book. Specifically, they would probably be accessed through a browser, whereas the user's own personal address book items would be accessed via a local application that was custom-designed for the client. The traditional browser model however would present the user with both an unnecessarily large amount of work, plus an illogical and unhelpful gulf between sets of what are essentially very similar capabilities and tasks. The idea of ADS is to get around this by allowing services to integrate into frameworks on the client

Overview of Client Aspects of ADS

ADS proposes a set of ‘service framework applications’ whose functionality can be extended and enriched through the addition of services. For example, continuing the example above, one framework application would be the Directory framework application. This provides a user experience (optimised for the client) for accessing directory services, such as local and non-local address books, yellow pages services etc.

Installation of new services may lead to new capabilities being added to the Directory framework application. For example, after subscribing to the Yellow Pages service, the user may have the option of submitting an address book query to the Yellow pages database as well as to his/her personal address book and corporate address book.

Note on Services vs. Plug-Ins

The above description makes the Yellow Pages service sound like a plug-in to the Contacts engine. While there may be some architectural similarities, one key difference needs to be highlighted: in ADS, services add capabilities to the device, which are manifested in appropriate framework applications, rather than just adding capabilities to a single application. For example, if a user subscribes to a Yellow Pages service, this may give the option of submitting a search string to the Yellow Pages database in the Directory section of the device. But it might also add the ability to browse for a certain category of listings (e.g. restaurants) based on the user's current location in a Location section of the device. So, from the above example it should be clear that subscribing to a service means adding a set of capabilities to the device as a whole. All or some of these capabilities (the ‘verbs’ of the service—e.g. ‘find’, ‘buy’ etc.) will be available to the user is one or more of the framework applications. A second example to clarify this point by subscribing to the Amazon service, it is possible that a user can “Search for products containing these words” from anywhere in the device; “Search for this CD” from my Internet radio application; and “Find books on this topic” from my News/content browsing application.

A Diagram of the ADS Device

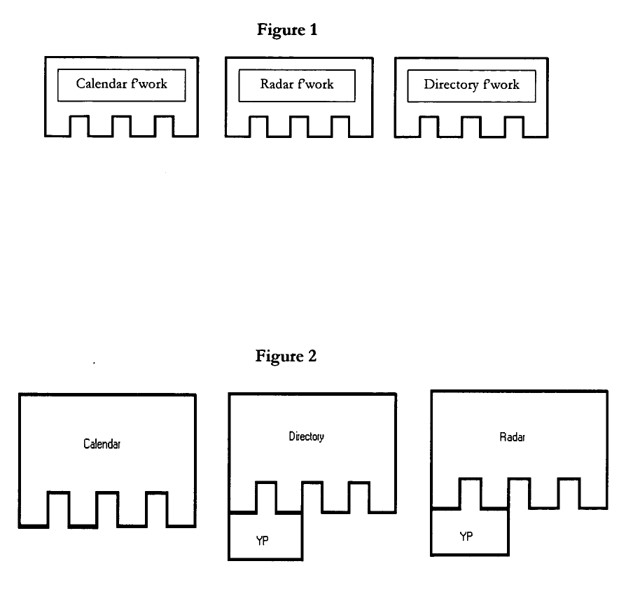

Given the above, the ADS device could be conceptually represented as shown in FIG. 1.

The three types of framework application in the above are just examples. The ‘Radar framework’ is short-hand for a framework application that constitutes the interface between the user and the informational environment around them. Application frameworks are contexts and sets of functionality (e.g. calendar functionality) that can be extended by services. For example, a Yellow Pages service might announce itself to the device as consisting of two main capabilities: the ability, given a search string, to list entries in the Yellow Pages database with contact details; and the ability, given a location, to list entries in a Yellow Pages database (these could also be combined.) In this case, one could represent the augmentation of the functionality as something like that shown in FIG. 2

In this example the Yellow Pages service has added:

(a) A search capability to the Directory framework application

(b) A search ‘for things in the area around me’ capability to the Radar framework.

(c) No new capabilities to the Calendar framework.

There could alternatively be just a single capabilities framework into which all services are installed; framework applications then use the capabilities made available by a given service via the capabilities framework.

The Framework Applications

Note on Service Installation and Architecture

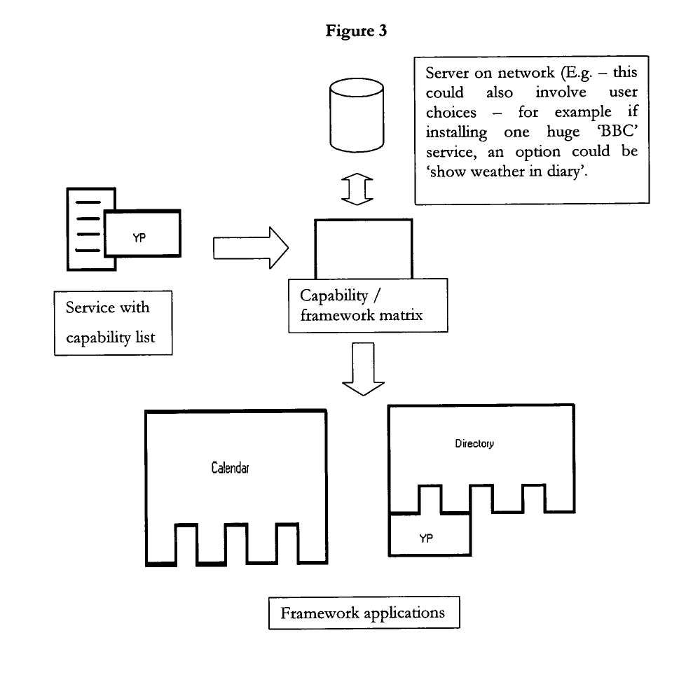

The kind of example above points towards certain architectural possibilities. In the Yellow pages example, one could imagine that part of the service subscription (or ‘installation’) process would consist of a negotiation as shown in FIG. 3.

That is:

1. The service announces its capabilities to the device

2. The device has a matrix that can determine which framework applications can make use of which capabilities.

3. Those capabilities are then made available in those framework applications.

4. Additional capabilities not yet included in the matrix can be looked up on the server, and the matrix values for them can be downloaded.

This approach presents one possible way of putting the control of the user experience in the hands of someone other than an individual service developer. That is, someone with a holistic view, such as the OS company, the network carrier or the user. It also raises the possibility of ‘extensible extensibility’: effectively what is happening is that, say, a Calendar framework application can have new APIs added to it as new services are conceived.

Interaction Between the Device and Services

A key element of this data services framework is the way data can go back and forth between the user's device and the elements of the service that are on the server (or on other clients).

For example, in the case of a BBC service which allows the weather to appear in the user's calendar, there is dearly a steady flow of data onto the user's device. But in cases like the Yellow Pages service, there is a two-way flow of information: the user is typically sending a request consisting of a verb and some other data, in order to pull further data down to the device.

The ADS framework allows this to function in a sophisticated way because tasks now take place in much more clearly-defined contexts. For example, in the old device model, if the user goes to a web site and starts searching for films, the service has no way of knowing the other parameters of interest to the user (times, prices, locations), and has to request them to be provided one-by-one.

However, the ADS framework in this case can naturally provide context information to enrich the service. For example, if the user has an Odeon™ film service installed, s/he could select ‘Find films’ from within a given day, or even timeslot, from within the calendar framework application. This means the request for data from the service would automatically include additional information about the time the user was interested in. Similarly, using the same Odeon service from the Radar framework application, the service could return a set of films showing at nearby cinemas.

Stringing Services Together

In addition to being able to use services within the context of framework applications, the close integration of services that ADS aims at allows services to be ‘strung’ together, so that the user may move smoothly from one service to another with a given chunk of data. (Instead, for example, of having to go to the Ebookers™ website to book a flight, then back to Outlook™ to insert the flight details in the calendar etc.) This could greatly benefit from, though does not necessarily require, a common, e.g. XML, schema for describing data).

This kind of service integration enables scenarios which span several services in the course of a single task flow, e.g.:

1. The user selects Friday evening in the Calendar, and uses the Odeon service to get a list of theatre events that evening.

2. A number of possible options are returned. The user selects one of these, a play, and uses a ThisisLondon.com service to ‘get reviews’ for the play.

3. Having read the review, the user uses the Odeon service again to book tickets. In the course of this, the Visa service is invoked to provide secure payment.

4. Having seen the film, the user goes back to the booking in the calendar and uses the Amazon service to ‘find soundtrack’ for the film.

Section D

ADS: ‘Identities’—User Interaction Aspects

This Section D discusses scenarios and user requirements concerning functionality based around ‘Identity’. Identity allows people to share information about themselves using their wireless information devices—i.e. it is a mechanism for establishing a virtual identity by posting information onto an extensible database. The framework needed to implement these scenarios is described in more detail in Sections F, G and H. Section H in particular give a real world example of an Identities type system.

Requirements and Issues for Identity

Terminology

Communicator—a person, application or service that is interested in contacting (through voice, text etc.) a Target

Data Blocks—discrete pieces of data that can have a specific visibility level assigned to it.

Identity—the whole gamut of information held about the user, some of which is created by them and some of which may be assigned to them as a result of their actions.

Mood—a setting which allows the user to provide an indication of their state of mind. This is likely to provide not only their state of mind but an indication of their availability and a preference for how they want to be contacted, i.e. if angry and busy, the user may have specified that this means they are only available for chatting in text form.

Target—a person that is the object of a communicators communication activity.

Creating an Identity

An identity constitutes a whole gamut of information some of which is created by the user and some of which may be assigned to them as a result of their actions. In order to create the identity in the first instance the user will however need to provide some information. The initial creation of an Identity must be a simple and logical process. Where possible as much data as possible should have been supplied on the user's behalf or assigned using sensible defaults. The user must be able to easily comprehend from the display of their Identity data exactly how their actions during creation and editing will affect the representation of themselves to other people. The user must be able to create more than one persona for their Identity and it must be possible for the data associated with that persona to be untraceable in relation to the overall Identity. This is, for instance, where users wish to interact anonymously with a service or person. It must not be possible for data associated with an anonymous persona to form part of a communication with any of the contacts with access to the overall Identity with which the anonymous persona is associated. It is important that Identity information does not hinder the interaction of a device. If, for whatever reason, a user does not wish to provide an Identity for themselves only the name field should be mandatory (ensuring that for the Targets the benefits of Identity continue to some degree).

The user should be able to enter the following basic identity data about themselves: all typical contact information including name, contact numbers and addresses etc. They should also be able to attach files and messages and make use of a variety of services that will provide Location, Availability and Mood information, Identity avatars etc. (Messages may include not only those being made visible to the Communicator but messages that are purely for the benefit of the Identity. For example reminders and notes associated with a particular contact or group.) The devices themselves should also be able to provide some of this information i.e. whether or not the user is in coverage, or that the user is in a call etc. The extent to which this is visible to a Communicator is dependent upon both their device and the visibility rights that the Target has assigned to them.

Once an Identity has been created this data persists and is made available to any new devices that a user adds to their retinue. They then manipulate that Identity in the future and all devices display these changes.

In addition, it should be possible for one's friends to push ‘cool’ enhancements for Identity avatars and Moods to each other. It should not be possible to enforce these on the other person, rather that they have the option to choose to accept the enhancements. The Identity information must be extensible to include new formats and services as yet unidentified. For example it is highly likely that 3^{rd} parties will create plug-ins to Identity avatars, i.e. downloading accessories for an avatar such that when a person is participating in a group call, users can signal to each other their views on comments with guns, halos or bunches of flowers etc. The Identity as a whole must be extensible to accommodate numerous 3 party services and applications.

Specifying Data Visibility

It is likely that the data provided by or on behalf of the user will have varying levels of visibility assigned to it. The view on what should be visible and what not will vary from user to user. While sensible defaults will be assigned to all data it is likely that some users will want to define this for themselves.

It is likely that Private data will fall into one of the following categories:

1. Invisible at all times. (i.e. account card passcodes).

2. Visible to specific people (or groups) at all times. (i.e. home address or credit card details).

3. Visible to specific people (or groups) for a specific period of time. (i.e. Location information).

When creating and manipulating an Identity the user must be able to categorise data clearly along the lines of Public and Private (taking account of private as defined above) should they choose to do so.

The user must be able to clearly identify data blocks when categorising them.

Specifying data visibility could easily become an arduous task for users should they choose to specify visibility levels for all their data. It must not be necessary for users to view their data in terms of visibility if they do not wish to. Sensible defaults must be applied to all data blocks to accommodate those users who do not wish to bother or are interrupted during the setup activity.

The user must be able to determine who is viewing their Public data, although this functionality need not be available at a high level simply as part of the Identity functionality.

The user must be able to change their setting in line with the activity they are currently attempting. They must also be able to access their Identity directly to make such changes. It must be a simple step (preferably a single step) to change a visibility setting, in particular location information.

At this time it is possible to specify that the visibility of location information should default to off; user research has dearly identified this need.

It is likely that the user will want to change some information on an ad hoc basis (i.e. Location information) for a specific period of time, i.e. for the half hour that the group of friends are trying to locate each other in town.

The user must be able to switch location information on for a person or group of people and should not have to go to an Identity view in order to do this, i.e. being able to select the person and allow access. Location information should only be visible for a pre-defined period of time. This period should be easily extensible by the user. At the end of the pre-defined period the location information should again become invisible. (Users may be warned about the end of the timeout and be asked if they want to extend the visibility period). It should of course still be possible to extend the visibility period to “forever” but this is something that the user must choose specifically. It must not be possible to easily action this by mistake.

Creating Buddy Lists

Some users will be prepared to allow specific people access to more of their data than others. These specific people or groups of people with greater visibility are referred to as Buddies. The user must be able, through a single action, to specify that a specific contact has buddy status.

At its most basic level, data is categorised as Public and Private. Through research, appropriate defaults will be assigned to the data blocks such that the user can be confident that in assigning Buddy status to a contact the Buddy will have immediate access to a reasonable but not complete set of the Identities Private information.

It is likely that some users will want to group their data according to specific buddy groups; parents and grandparents may constitute one Buddy group and will have access to some of the Private data, i.e. holiday photographs, but a close circle of friends may constitute another Buddy group that has access to photographs from a night out at a party. The two groups of data both constitute Private data but their visibility are each restricted to specific Buddy groups. Similarly a Buddy group of colleagues may see one type of Mood but a group of close mates forming a specific Buddy group may see a completely different representation.

The user must be able to categorise their buddy list, i.e. they may group buddies together that have specific interests in common, such that they can assign an entire group access to specific data blocks and all other Buddies and normal contacts will be unable to see that data.

Once a contact is assigned buddy status the user must be able to easily access that Buddy's settings for the purpose of changing these.

It must also be possible for the user to be able to look at their Buddy and determine exactly what that Buddy is currently viewing. This is because while the general Identity information may be displaying one view of the information in the public domain, the buddy may have been assigned a different representation of that same data or setting, i.e. the Mood setting in the Public view may show one representation of the Identities avatar, but a buddy may see another. Issue: Users probably need to be able to specify different types of availability based on a specific contact, i.e. when a parent views their child's Presence they see that they are not available because they are in the classroom, however their buddies may see that they are available for chat. Location information, even for a buddy will be off as default

Creating and Using Moods

The user will have access to a default set of Moods when first creating their Identity. The Mood forms part of the data available to a Communicator when determining whether or not they want to contact and indeed how they will contact the Target In the first instance Moods are likely to offer generic poles of the most useful Mood indicators, i.e. Happy/Sad or Happy/Angry.

It should be possible to add more Mood layers to an Identities avatar.

Moods should, when applied to an Identities avatar, give clear signals as to the meaning of the Mood in both audio and visual formats. (Mood information should be meaningful in both as it is likely that many communication activities will be increasingly initiated without the handset).

It must be possible to assign visibility levels to Moods in the same way as all other data blocks.

The ability to switch between Moods will only be used proactively if a) users perceive there to be significant user benefit to doing so, i.e. because it genuinely improves their phone experience or simply because it is seen to be “cool” b) it is extremely easy to do.

Once created:

The user must be able to switch between moods quickly, with a single action. It is possible for a Mood to impact the way in which a communications are displayed to the Identity.

The user should be able to download new mood poles. These can replace the default Moods or be used in conjunction with the Moods. Buddies may therefore be able to see a different Mood representation from that being made Public generally.

It will be possible to add features to an Identity's avatar; Moods must be able to accommodate this.

Moods are not simply there to give a Communicator a view of the personality, state of mind and availability of a Target; it is also a tool for a Communicator so show the Target more about themselves prior to or during a communication. For example: When a Target receives a communication, be that a message or a call request the current Mood etc. of the Communicator will accompany the communication.

A Mood should by default accompany a communication or request for communication to commence.

A user must have the ability to stop a Mood being sent with a communication.

If the communicator has specified that the Target is a Buddy and therefore has access to a specific Mood and Identity Avatar; this representation will automatically accompany the communication instead.

It is highly likely that some users will, on occasions, forget to change their Mood/Availability information.

On receipt of a new communication, be that voice or the the user must be able to suddenly switch settings through a single button press. In the case of an incoming call the user should be able to use the Mood switching activity to divert the call, simultaneously pushing the new Mood/Availability information back to the Communicator.

Setting Availability

When specifying availability, the following options are required, though the user may customise this list for ease of use: Available (all communication forms get through), Available for text only (IM and SMS formats are successful, Communicators are advised to use these, however the Identity can enforce this in which case non text based communications go straight to Voicemail), Available for SMS only, (Unavailable for any form of communication).

It should be possible for a user to utilise the calendar application to supplement the availability information. However this should be an option (not a default) as accurate usage of calendar applications is sporadic.

It is likely that some users will want the ability to use their Moods/Availability information to actively control the way in which they are contacted. Therefore for the Communicator looking at a Targets Identity they may see that the person is only available for text chat and this will mean that if they attempt a call it will be bumped to Voicemail.

Moods and Availability settings should be extensible to allow a user to specify that their settings actively control access of a Communicator. It should not be the default that a Text Me setting automatically forwards all calls to Voicemail.

Viewing Identities

Own Identity

A user's Identity constitutes the full gamut of data held about them; this may include any or all of the following: basic contact information, credit card and health information, files (i.e. pictures, sounds, video, documents etc.), messages and preferences, Identity avatars and Moods etc. The extent to which this data is visible on any one device is dependent upon the devices capabilities.

The user must be able to easily access their full Identity at any point in time and view/edit their Identity immediately.

The user must be able to easily determine at any one point in time, preferably without switching out of a current view into a specific Identity view, what Identity they are displaying Publicly. This is particularly important for the Identity avatar and associated Moods as these are likely to be the most immediately visible elements of a persons Identity when being viewed by others. (Watermarks and various other mechanisms are under investigation).

The user should be able to view and manipulate their Identity regardless of the device from which they are accessing their Identity. If the device is unable to accommodate some of the data, the user should be clearly informed of this. Inability to display information must not restrict access to or disrupt the display of the remaining Identity data.

If a user has allowed Buddies to see specific Identity avatars and Mood information (and this differs from the current Public equivalent) the user should be able to easily determine this through their Buddy view.

Another Person's Identity

When considering initiating a communication with another person, the use of Identities ensures that there is a variety of information available to the Communicator. The extent and visibility of this information is dependent upon the amount of information that has been created by the Target and the extent to which the Target has made it visible to the particular Communicator as well as the viewing device's capabilities.

A Communicator looking at a Target must have access to the fill set of data available to them as dictated by the visibility settings defined for them by the Target (The Communicators device should be the only factor determine the extent to which this is possible).

When a Communicator actively chooses to ‘look’ at the Target they know that they are viewing the most up to date information, although a delay in such data being displayed should be negligible.

If a Communicator is unable to accommodate some of an Identities data, the user should be dearly informed of this. Inability to display information must not restrict access to or disrupt the display of the remaining Identity data.

The user must be able to restrict the amount of Identity data displayed on their device at a global level.

The user must also be able to restrict the amount of Identity information displayed in relation to a specific individual or group.

The Communicator should be able to send a request for specific data to their Target. If the request is accepted the data will simply refresh in the Communicators view.

It will be possible for a Target to use their Mood and Availability to actively control the way in which they are contacted. It must be possible for a Communicator to override a Mood/Availability setting i.e. with the use of a pre-agreed number or some other break through mechanism—under investigation is the Communicator holding down the call button to indicate urgency—this would also provide the Target with a scale of the perceived urgency of a call that was trying to break through their Mood barrier.

Security

It must be possible for a user to create a persona that is anonymous and which cannot be traced back to the overall Identity.

It will be necessary to support mechanisms that enable a user to validate that the Communicator is indeed who they say they are.

It must be possible for an Identity to determine at any point in time who has access to each part of their data.

A user must be able to control which users (probably Buddies) can update their Identity. They must also be able to add the right to do this on an ad hoc basis.

A user with access to an Identities data cannot share this with another user without the express wishes of the Identity.

Communication Goal

It is critical that in defining new communication paradigms the functionality of IM, voice telephony, SMS and the features of Identity etc. be integrated such that continuity, i.e. the sense of a conversation—be maintained. For example: textual data can be exchanged as an initial step in a communication and the users choose to ‘step-up’ to a voice call, with the freedom to step back down to text if need be, i.e. a message with a sad mood may be sent with the words, “Can you talk?”. The recipient may respond with voice communication and if someone else then walks into the room one of the parties can easily return to text for the sake of discretion without breaking the communication.

Secti nE

ADS: Shared Content

Shared Content

This section discusses scenarios and user requirements concerning functionality related to ‘shared content’. As with the preceding section on Identities, the technology implementing shared content is described in Sections F, G and H User requirements and issues regarding shared content

Terminology for Shared Content

This section deals with shared content that is owned by an individual.

A sharing list is the list of people with whom the user chooses to share one or more pieces of content Individuals on a sharing list are not aware who else is on the same sharing list.

The list of requirements below address both sharing of static content and the sharing of ongoing activities.

Key User Requirements for Content Sharing

The following user requirements regarding the sharing of content reflect the need for it to be easy:

Users must be able to share any of their content or activities with individuals and groups with ease. The user tasks involved should simply be selecting the content and selecting the individuals or groups with which it should be shared.

In some cases, such as online photo albums, there is a need to share content that is (at least initially) local to the user's device. In these cases, it follows that:

Users must be able to share content local to the device and have any uploading to a server handled automatically. That is, the user should not be required to perform an extra ‘uploading’ step in order to be able to share the data.

Sharing Lists

Users should be able to share their content and activities with:

Individuals from an address book or buddy list,

Categories of individuals from an address book or buddy list,

A private group from a previous activity,

Anyone who may be interested (i.e. make the content available to everyone),

Or any combination of the above.

Further, because sharing of a current activity or object brings its own set of scenarios (e.g. sharing a document during a meeting), the following user requirements are introduced: Users should be able to share with ad hoc classes of users, such as ‘People within Bluetooth range’, or for greater privacy ‘Everyone in my contacts directory who is also within Bluetooth range’.

Sharing Sessions

Sharing the current activity differs from sharing content objects in that The user can share navigation and actions on that piece of content (e.g. of a document) while sharing is going on.

Additionally, the user may want sharing of an object or activity to end as soon as that particular activity is over. It should be easy for the user to set this as an option.

Visibility of Sharing Status

It is vital that users are aware (and in control) of which parts of their content and activities are being shared with whom. So users must be able to easily and clearly see which individuals or classes of individuals have access to any given activity or piece of content. Similarly, if the user is sharing a current activity, this fact must be visible at the top level of the user interface.

Natural Privacy

Some types of content, for example credit card details, should not be shared regardless of the current context

If the user is sharing an activity and that activity involves confidential information, it should be straightforward for the user to ensure that the confidential information itself is not shared with the other parties.

Notification of New Shared Content

Users should be able to optionally notify the members pf the sharing list for some content when that content is updated.

Sharing Content that is Already Stored in the User'S Part of the Server

Users must be able to publish content that is already stored (and conceivably shared) in their area on the server to specific groups.

Sharing of Content Types

It should be possible for the user to share content by type, rather than just set sharing options on a piecemeal basis. For example, a user could have a rule that all data of ‘Holiday photos’ type is shared openly.

Also, in order to maximise usability and appeal, it should be possible for the user to associate ‘templates’ with designated content types, so that, for example, ‘Holiday photos’ are presented to viewers in an easily navigable and personalised ‘photo album’ applet.

Permissions

The classes of access to content should be:

Owner: the owner(s) of the content. Owners can create, edit and delete content

Guest the viewers of the content. Guests may include ‘everyone’ in which case the content is wholly public. Guests can view content, and may be able to edit parts of it.

Only individuals with Owner status can set permissions. Permissions cannot be transferred to other users.

Privacy Between Content Viewers

By default it should be the case that:

Any given viewer of a user's content should not be able to see who else has access to the content That is, by default sharing lists themselves are confidential and not shared.

Privacy Between Content Types

Individuals accessing part of a user's content should only be able to see the content that they have access to.

Storage of Shared-Content

Where content is published to a particular group (for communal ownership), that instance of the content becomes part of that group and deleted when it is deleted from that group. Therefore, publishing content to a group should not delete the user's copy in his/her private data store.

Deletion of Content

Users should be able to delete any content they have shared, whether this is in a forum or in their own individual area.

Read-Only vs. not Read-Only

Content publication and sharing should not necessarily be a one-way process, but should allow discussion and dialog.

Users should be able to easily provide the facility for others to contribute and comment on their shared content, e.g. via a message board.

Section F

Server Side Aspects—General Comments on the Enabling Technology

Purpose and Scope

The purpose of this Section F is to demonstrate the suitability, or otherwise, of the facilities provided in the standard framework for implementing commercially viable services. It looks at the usefulness of the services framework for implementing services that have been identified as being commercially desirable. We shall look at the suggested phase 1 services initially, Group Games & Forums and then look at a phase 2 service, golden vcard. This section is merely intended at demonstrating the applications of conceptual facilities to commercial service requirements.

Group Games

Group Games Description

Groups interacting between each other via games have two different models, the first is that they play a game on their own and simply submit their score to a shared highscore table, allowing people to compete at being the best at a game without actually playing against each other. The second model is that they actually play against or cooperatively with someone else in their group.

Games in this second model can be broken down based on two characteristics, first whether or not they are turn based, turn based games allow players to make their move which is sent to another player or to a server to be broadcast, after this it someone else's turn and so on until everyone in the group has had their turn, non-turn based players allow everyone to play at once. The second characteristic is the turnaround of moves, a chess player may need to consider their move for longer than a tic-tac-toe player, so games can be defined based on the speed of turnaround. With these two characteristics we can split games into four categories each with its own functionality requirements, the following table indicates this division and some of the games that fall into each category.

| | Turn Based | Non-Turn Based |
|---|---|---|
| Slow Turnaround | Chess, strategy war | Multi-user text based |
| (seconds) | games | games, some strategy |
| | | games, Forums |
| Fast Turnaround | Tic-tac-toe, hangman, | Multi-player action |
| (fractions of a second) | battleships. | games |

We now have five different group game types, first the shared high score table game and then the four categories defined in the above table, to investigate whether or not the proposed services framework supports each of these game types, apart from slow turnaround, non-turn based games which is covered later in Forums, we will look at a sample game and see what its facilities requirements are and how they can be supported by the services framework.

Solitaire

Solitaire is a game played alone, the only way in which it can be made into a group experience is by having a shared high score table. An additional feature that could enhance this is that players automatically published their high score tables so their friends can see them. Lets state the requirements in terms of a framework for creating this type of application.

Application must check to see whether or not the completed game is a new highscore

Application must update the highscore table if it is a new highscore

Application must publish its own highscore table if it has changed

There are some flaws with this current implementation, first of all someone could change the global highscore table with a score that was not a highscore. Next the person may not have coverage in their current location. Finally the person may not want to publish their highscore table to everyone, for instance their boss may be a little worried that they have become a solitaire expert over the course of their employment

So with these flaws in mind we can change our list of requirements:

Application must be able to create an offline or online message stating their new highscore and send it to a server.

Server must be able to manage its own highscore table.

Application must be able to publish its own highscore table.

User must be able to restrict access to information on a user by user basis.

Application must be able to synchronise more than one highscore table.

System must do authentication of data.

If we now change these requirements to a list of technical features for a framework, we get the following.

Flexible real-time and batched messaging

Support for small server side message handling applications

Synchronisation of data between server and multiple devices

Flexible server-side personal data storage

Trust relationships

Standard authentication

These are all features that the services framework includes, so at least we now know that the proposed framework allows people to play feature rich shared highscore games of solitaire.

Chess

We will now conduct the same style of exercise with chess. Chess is a typical slow turnaround, turn based game. Users should be able to start a game with a friend or perhaps even a stranger, and then play the game over the course of either minutes or months.

Users must be able to find other people interested in playing

Users must be able to record previous chess partners

Users must be able to exchange moves both offline and online.

The first condition means that people have to be able to flag that they would like to play and people should be able to search for other players, but perhaps not know anything else about them. Also we know that moves can be handled by messages so we are going to restate a requirement that came up previously for the Solitaire example, this shows that the framework has early signs of being reusable.

Flexible server-side personal data storage

Unique searchable naming system

Fast public data searching

Flexible real-time and batched messaging.

Again the framework supports all these features and they are also reoccurring in more than one game application, however this is not as important as the facilities being reused by non-game applications.

Tic-Tac-Toe

While Tic-tac-toe is unlikely to be a very popular game, it does compare and contrast well to Chess, it will require almost exactly the same facilities as Chess, the one change will be that the messaging component will have to perform quickly enough for people to be able to play a game like tic-tac-toe.

Prediction of the speed of the system is currently difficult, the major bottleneck is likely to be in the GSM/GPRS interface.

Flexible server-side personal data storage

Unique searchable naming system

Fast public data searching

High performance real-time messaging.

Multiplayer Doom

The different between turn based fast response games and non-turn based fast response games is the amount of data and the processing required to keep up with it, it is unlikely with early: bandwidth predictions that this sort of game will be easily implemented and it is definitely not a candidate for the services framework.

Forums

Forums also known as chat rooms are likely to be very popular on wireless devices, especially in light of the success of SMS. Simply put a forum allows several people to be part of a “channel” or room, which is usually themed; for instance supporters of a football team may meet in a channel devoted to that team to discuss the team. In this example the channel may only be in existence when a game is being played. These mechanics have been well established in existing Internet based forums, but the question is what facilities are required to implement a forum service and how are they addressed by the proposed framework.

The use of the naming and data server can be applied equally well to both public (e.g. IRC) and private services, however some bespoke development will be required for existing public services.

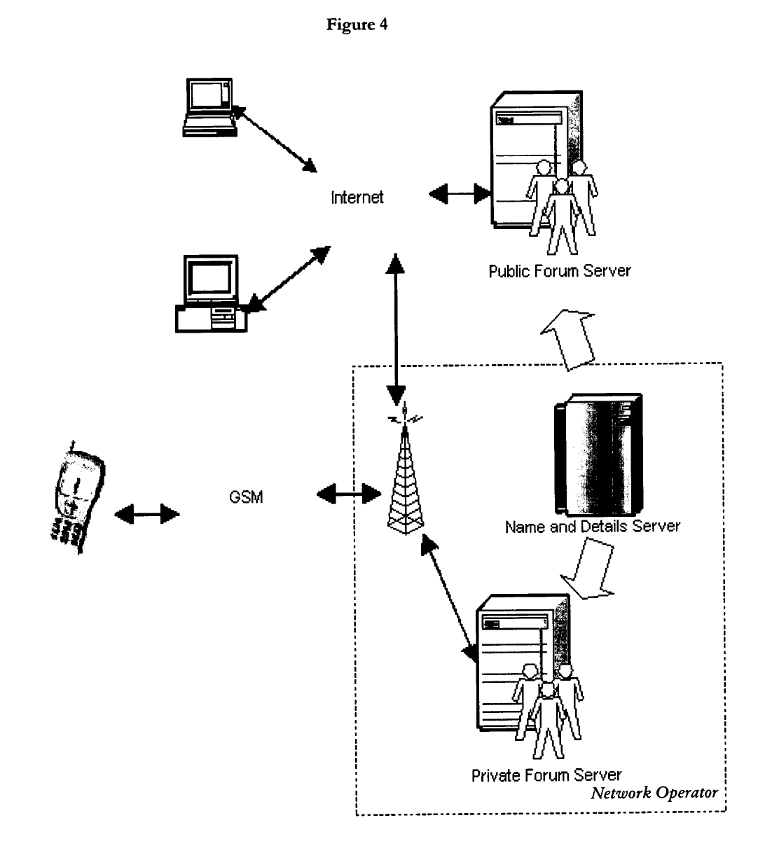

Looking at the use case (shown schematically in FIG. 4), the user logs on to a forum, he or she will have a name associated with them, it may be a nickname instead of their real name. It is important that when they choose this nickname that someone else cannot steal it from them. Once they are logged on they can exchange and receive messages with those also on the channel.

Again we can go through the previous paragraph and generate some requirements for our framework

Flexible server-side personal data storage.

Authentication

Real-time messaging

Again we are seeing as predicted that the facilities required for previous services are re-occurring, this is a clear indicator that a standard way of implementing services is desirable and that services can reuse “off the shelf” components, namely parts of the services framework.

Golden vCard

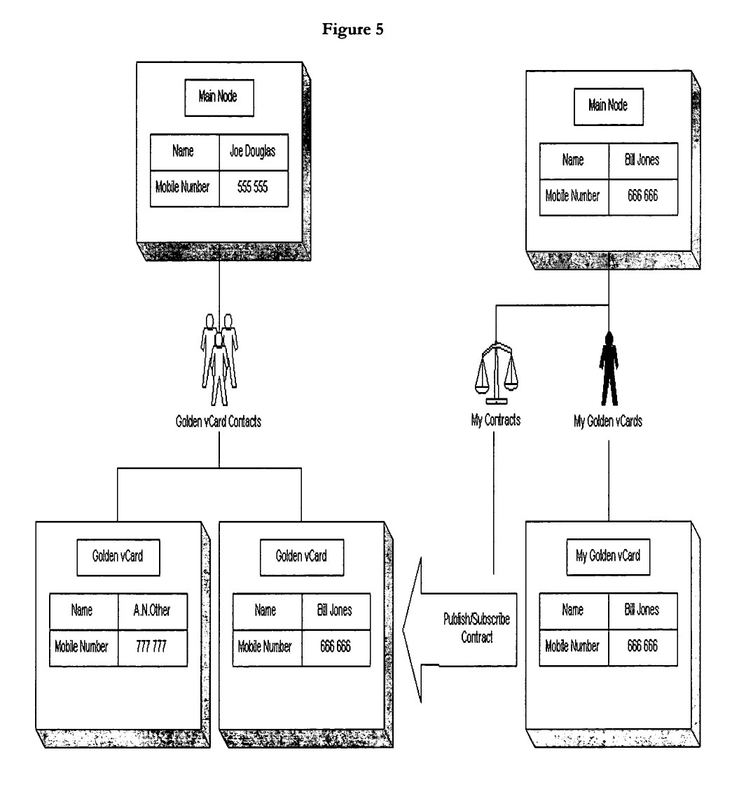

A Golden vCard is a vCard that once given automatically keeps itself up to date. If you give someone a Golden vCard you are really giving them a vCard and a contract of trust that they may receive any changes to the fields of your vCard that you may implement later. The FIG. 5 diagram illustrates the situation where Bill Jones has given his Golden vCard to Joe Douglas. Joe now has a copy of the Golden vCard in his online contact list however more importantly Bill has a contract set up to publish changes to Joe.

Rather than analysing the problem this time, we will state all the facilities that have been used up until this point, summarise them into one list and then see how each of them can be used to deliver golden vCards

To recap, the following facilities have been used so far . . .

Solitaire Used . . .

Flexible real-time and batched messaging

Support for small server side message handling applications

Synchronisation of data between server and multiple devices

Flexible server-side personal data storage

Trust relationships

Standard authentication

Chess Used . . .

Flexible server-side personal data storage

Unique searchable naming system

Fast public data searching

Flexible real-time and batched messaging.

Tic-Tac-Toe Used . . .

Flexible server-side personal data storage

Unique searchable naming system

Fast public data searching

High performance real-time messaging.

Forums Used . . .

Flexible server-side personal data storage.

Authentication

Real-time messaging

Combining and summarising them to a single list we see a lot of commonality, we will now go through this list and see how these features could be used to implement a golden vCard service.

Fast public data searching

Fast public data searching may be used as a way to find people before establishing a golden vCard

Flexible real-time and batched messaging

This can be used to build lookup applications

Flexible server-side personal data storage

This can be used to store the user's own vCards and the details of others

High performance real-time messaging.

High performance messaging is not essential for this service

Support for small server side message handling applications

It is not clear how this feature could be used for golden vCard

Synchronisation of data between server and multiple devices

This is essential for synchronising devices such as PDA with your set of golden vCards

Trust relationships

This can be used to setup to publish/subscribe relationship that is at the heart of the vCard

Unique searchable naming system

This could be used to find people on the system to request a vCard from them.

It seems clear from this analysis that again the facilities offered by the ADS framework are useful in delivery of this service.

Conclusion

We have looked at a small number of applications and it is clear that the initial framework is capable of delivering them. It is obvious that the framework will become more refined as services are implemented on them, however a module design based on open standards will allow this. The framework will be useful outside of the wireless arena and it desirable and important that it is adopted elsewhere in order to avoid a closed proprietary framework being established.

The most important thing to come out of this brief analysis is the level of reuse in this services framework and that benefits not just the services but each of them becomes richer due to their shared heritage; the real strength may be that after exchanging a golden vCard a user can at sometime in the future establish a game of chess based on that contact.

Section G

Server Side Architecture—ServML

Purpose and Scope

This section is intended to give an Overview of the ‘ServML’ Framework proposed for ADS. The section describes the requirements for a wireless services Framework, the facilities for such a Framework, and how the Framework would enable ServML Services.

The ServML Framework describes a means of storing, accessing, and interacting with data using a client-server architecture. It is optimised for access to data or services using Wireless Information Devices, whether these are hosted on Internet servers or other Wireless Information Devices. It takes advantage of the power of Symbian advanced clients, providing a fit for purpose platform to deliver, maintain, and control the flow of information between the clients and the server. ServML embraces existing standards and initiatives such as SyncML and XML and uses standard data transports such as WAP or http for data access.

Current Internet technology offers a set of services that are not very different to the dumb terminals of the 80's, where the main mode of operation is accessing read-only text with a browser with other capabilities retrofitted in a less than optimal way. This is powerful largely because of the ability to hyperlink different pages together, creating the infrastructure between separate information sources.

Unfortunately, the current architecture of the Internet is not well suited for the wireless device form factor, providing an inappropriate user experience (the browser/page metaphor) for mobile devices with small displays. The screen requirements of the page metaphor are larger than can be easily carried around and used on the move. Furthermore the browsing nature is not ideal for a busy person on the move.

To evolve this model to be more useful and enjoyable experience, a richer set of capabilities needs to be provided. Not only has the need to access the information moved from the desktop to ‘anywhere, anytime’ with mobile devices, we are also seeing increasing demand to move from ‘hypertext’ to ‘hyperinformation’ (i.e. data whose semantics are defined so that computers can manipulate that data in a content-sensitive way). Hyperinformation and the semantic web have been hot topics recently in the W3C with Extensible Markup Language (XML) being seen as the technology likely to deliver this next generation web. This move also means that we may move away from the browser as the primary and in many cases only tool for accessing information services and see the birth of a new paradigm, in which the Internet enables services. Although the server architecture is in many ways identical to the present Internet the usage model is quite different Instead of a passive data-viewing function, the Internet and its servers can be used by a mobile device to deliver enchanting services that far surpass the present PC-Internet model.

The result will be the ability of wireless information devices to interact closely with applications and data on the Internet to deliver high quality services. An open standard is needed to make this a reality and to prevent a proliferation of proprietary solutions that each serve only a small segment of the market.

Requirements for a Framework

Some of the following requirements are applicable to both wired and wireless Internet access, some are more specific to just wireless devices. It is important to note that users will want in the future to access data and services from a variety of terminals and devices. Therefore, ServML must be applicable to the Internet user as well as the WID user.

Perception of Security

One problem with the current Internet, as with any infrastructure that grows in an evolutionary but to some extent uncontrollable way, is that infrastructure was not designed to provide perception of security. A systematic approach to security is therefore needed, one which aims to guarantee that transactions made cannot be compromised. Perceived security also gives rise to the challenge of identity, a person's identity on the Internet is currently represented by either proprietary ad-hoc data solutions or a homepage, neither is likely to suit a move to the next generation of services.

Extensibility

Just as the IPv4 standard turned out to be too limited in space, requiring IPv6 with nearly infinite address base to be created. Anything that is designed to solve current and future problems needs to be designed with ample room to grow and expand.

Use of Open Standards

Using a standardised way of working, rather than proprietary mechanisms, is a commonly accepted goal in modern development Standards enable inter-operation, and leverage the existing work. Not only does it normally end up being a better product, it also provides economies of scale, the current GSM standard being a good example. Open standards such as X and SyncML can provide a common set of tools across the industry, increasing uptake.

Ease of Deployment and Use

Any new technology will face an uphill battle if it is difficult to adopt and deploy or if the end user needs to change their patterns of activity to accommodate the new technology. Particularly for the mass wireless markets, significant attention needs to be paid to the ease of deployment of these new approaches and to the issues of data representation and manipulation in order to enable mass take-up.

Enabling Facilities for Framework

Our analysis and experimentation has led us to believe that there are a set of core facilities that are used again and again within services solutions. In this section we will look at these facilities and discuss at a high level the requirements for their provision.

Identification

A unique ID is the Holy Grail of governments, marketeers and web sites. However it is also one of the most feared concepts by freedom groups worldwide. It is unlikely that any solution will bring about a unique identification scheme, however there should be support for multiple identification schemes and there should be provision for a preferred naming scheme for wireless services. We need to address the concerns of the freedom groups in our security model & framework generally, for instance users should also have the option to prevent access to even their public information via a directory lookup.

Identification is very related to Identity and it is likely that some form of Personal Storage System will implement Identity.

Authentication

There is a need for authentication of the user when they access their data perhaps via their WID. This authentication should prevent access to their information both locally and on the server (for instance if their device is stolen). The authentication can use a number of different mechanisms: a basic WID and password/passphrase is likely to be first line of access. Once past this stage the WID may store private key(s) transparently to the user of the WID that will allow access to services. The private key effectively represents the ownership of the WID to the server side session. Once again, a number of emerging standards can be adopted directly to provide this functionally.

Contracts

The concept of a contract initially may be a special case of allowing access to information that the contract holder may not normally have access to and also perhaps govern how they can use this information. In order to govern this, there may need to be some level of legal framework surrounding contracts.

One of the key areas that needs to be considered here is how contracts can be established offline in a similar manner that electronic business cards are currently exchanged via IR.

Offline Contract Establishment

There is a need for contracts to be established between two Wireless Information Devices (WIDs) which, can communicate with each other (e.g. via Bluetooth or IR) but cannot or do not want to access a server. There are four mechanisms for this:

1. The parties establish a contract and both parties later upload it to the main server in an authenticated session. We shall call this double unload unsigned contracting.

2. The parties enter into an initial negotiation and identify each other. As required, one or both parties sign a contract, that contains identities and this is then used by the other party as needed. We shall call this single upload unsigned contracting.

3. One of the parties as required signs a contract that does not contain identities. We shall call this permission slip contracting. To understand this form of contracting more clearly and indeed all of the forms, we can think of the three steps visually . . .

Step 1

Mr White sends Mr Black, a contract that defines the terms under which Mt Black can interact with Mr Whites resources on the server, this contract is digitally signed by Mr White, probably via a private key on the WID.

Step 2

Mr black presents his contract at a later date to a server representing Mr White in some way, perhaps it is Mr White's personal storage system. The server will validate the contract, for instance by checking it against Mr White's public key.

Step 3

Once validated in Step 2, Mr Black can interact with the representation of Mr White on the server under the terms of the contract (i.e. the data or services that are offered by Mr White's server to Mr Black).

4. The contract is established, signed by both parties and then doubly uploaded. We shall call this double upload signed contracting.

Each of these contract establishment processes has different levels of resource use and almost always an inversely proportional level of security. What is still unclear is whether we need to simply have one standard way for establishing of line contracts or more than one. It is clear however that there is a need to reduce the scope of contracts to limit the complexity. Ideally contracts will grant access to only one party's resources and the recipient will use this contract as simply a permissions mechanism.

The last of the options, double upload signed contracting is without doubt the most secure option and it may be that this should be the only mechanism offered in order to provide a high integrity system at the expense of more resource (and possibly user) friendly solutions.

Options that involve signing require a private key to be stored on the device in order to perform the digital signature operation. This brings in the requirement for secure storage on the device, perhaps in some form on encrypted storage system so that if the phone is stolen, the key is not compromised (this is already possible using standard technology wherein the private key is held in the SIM and a session key is generated for all transactions).

Naming

There is the need for some form of lookup service in order for people to find others using services. Once found they can then store the unique ID in their contact manager (thus eliminating the need for multiple look-ups unless the link becomes invalid). This is similar to DNS except that names should probably only ever be resolved once and the unique ID should then be stored. However there is the need for the same caching/resolving structure and a root registry system. Due to privacy concerns there is a requirement that the user can opt-out of name resolution.

Personal Storage

XML Hierarchy

Extensible Markup Language (XML) is increasingly being used to get around the problems of proprietary ways of representing data on the Internet. Not only does it provide a better definition of data, it is also extensible through the use of Document Type Definitions (DTD) and therefore sharable with others. XML also provides a suitable hierarchical structure to represent data.

XML vs. Pages

ServML is designed to use XML to store and transfer data. With XML the data can be presented in a way that allows logical storage of personal information in the server. Unlike Hypertext Markup Language (HTML), which can only provide a crude layout of data, and often using proprietary mechanisms, XML is a standardized, platform independent and extremely robust way of describing the data. XML can therefore be optimized to handle many different types of data in a flexible, yet precise manner.

X-Folder

In order to build a functional hierarchy, we may need to define several sets of data by using XML schemas or DTDs. One of these suggested types is X-Folder, which allows a standard representation of folders that contain only one type of data, e.g. contact information. This will allow for better compression techniques and hence more efficient handling of data, given limited bandwidth of the wireless client.

XML Schema for Standard Data Types

As mentioned above schemas may be needed to define certain types of information. Similarly, certain types of data types should also be defined as schemas in a standardized manner. This enables sharing of schemas across the Internet making sharing of information much easier.

XMLification of Vcard

An example of this ‘XMLification’ is work currently under way of defining VCard standard as a XML DID. While not yet standardized format, it demonstrates how information is increasingly being reformatted to XML.

Need for Standards Body/Mechanism

In order to do this type of XMLification, a standards body will need to be involved to oversee the process and make sure it serves the best interests of the wireless industry. While the Internet user community can often advance the standards, a standards body would accelerate and focus this process.

Searching

Having data stored in the server in an organized manner is not sufficient in itself. An efficient mechanism of searching the data is also required and XML is again more fit-for purpose than the alternatives. XML allows data to pass through firewalls and it is defined in a way to make searching much more efficient and precise than traditional HTML

XML Query

W3C has formed the XML Query working group to standardise the querying of XML documents. They are likely to produce standards for the request and results of queries along with some form of query algebra. This will mean that they are likely to produce something akin to SQL but aimed at XML rather than tables and fields. This standard will give rise to XML Query Engines that will provide fast querying and hence rapid searching of XML material, based on indexes similar to database queries.

Linking, Pushing and Polling

With distributed information systems, there is an issue of how relationships between the information are presented and processed. With a page based system such as the World Wide Web (WWW) this is normally done with hyperlinks, that allow the user of the system to click on a link and move to the related information. Client software can also automatically follow links and either cache them in advance to increase the speed of access to related information or present the related information within the current page view (this is done for images with most modern WWW client software where the image link is followed and rendered if specified using the <img>tag).

Manual link following is not appropriate if there is a move to using information applications as opposed to page browsers. This means that if an information object that references remote information is used it can either be looked up at read time (automatic link following) every time the object is used and hence the remote information will always be as up to date as possible, it can be read once and then periodically refreshed (polling) or when the remote object is updated it can push the information out to all the objects that reference it (pushing). Each of these strategies has strengths and weaknesses.

| | Strengths | Weaknesses |
|---|---|---|
| Link following | Data is always up to | Requires a remote read |
| | date | every time leading to |
| | | processing overheads. |
| | | Depends on network |
| | | availability to remote data. |
| Pushing | Data is almost always | Requires the maintenance |
| | up to date | of a publish/subscribe |
| | | database |
| | | Additional Implementation |
| Polling | Can be scheduled to | Data may be out of date. |
| | suit resources. | Processing may be needless |
| | | as remote data may not |
| | | have changed. |

As with everything, the choice depends on the specific problem. In this case the problem can be categorised by the frequency of updates. With personal information storage from periodically connected devices, pushing is an attractive approach assuming the data does not change too regularly or that there are too many subscribers to a particular piece of information.

An ideal system should support all 3 methods so that if the information other than personal information is stored it can be supported optimally. It is likely that in the future the distinction between the local information stored on a WID and the information stored on a server will blur further. More detailed information about the building blocks of these methods are described in the later sections.

Permissions

Permissions on the personal storage component are vitally important to give a feeling of security to the owners of private and potentially sensitive data.

Permission Management

To provide this sense of control, the interface and mechanism through which users manage their information must be clear and simple. There is a risk that as the personal storage system grows the complexity of the permissions mechanism will increase, especially as they develop privacy relationships with groups and a one to one relationships with web merchants.

Groups

Group permission management is a way of simplifying permissions and provides a sense of community within the overall system. Groups should be managed by a more general contact manager system than those currently seen on the platform. While the integration of group and permission management functionality into a contact manager is non-trivial, it is also highly desirable in order to provide an integrated feel to the experience of using services.

Contracts

One mechanism to simplify the management of permissions for case by case scenarios is the use of a contract. A contract is simply a permission object that is signed by the owner of some information and allows named individuals to access information in a manner prescribed. Someone holding a contract will effectively have limited access as if they were the signatory of the contract. This helps reduce the complexity of permission management, provides a workable way of implementing the system and constrains security into a smaller area of the overall system.

SyncML

SyncML is an industry standard that defines how two devices, client and server, handle synchronisation. Apart from the synchronisation protocols SyncML is also used to store the information on the server.

Overlap with Schema Usage

Similarities between SyncML and XML schemas exist to suggest that different variations of coexistence exist between the two. SyncML uses XML as a markup language to store the messages, which enables open, standardized way of coding SyncML data across ServML.

Similarly, many existing server storage systems are implemented using XML, which would make co-operation between the two types of storages relatively easy.

Need for Open Standards

Just as with other implementations of personal storage, the possible designs that combine SyncML and XML schemas need to be standardized. Without standard way of operation, the storages would never gain the level of acceptance that is required for a mass market solution.

Messaging

Communications

ServML requires a communications standard for the delivery of services. After some research the Simple Object Access Protocol (SOAP) has been selected as an excellent candidate.

SOAP Overview

SOAP is a wire protocol like Common Data Representation (CDR); it is rapidly emerging as a future standard for accessing services on top of the existing Hypertext Transport Protocol (HTTP) based structure of the Internet, along with other transport existing protocols such as Simple Mail Transport Protocol (SMTP). It has been called Remote Procedure Calling (RPC) for the Internet and standardises what many people where already doing for advanced B2B and B2C services. Put simply it uses XML as a structure for the encoding of service request, response and error messages, which can ideally be used in a intermittently connected wireless devices.

The use of existing structures is essential in order for any standard to be adopted since corporate infrastructure and security facilities such as firewalls are already tuned to these structures. Also the flexibility offered by the choice of transport protocol—HTTP., SMTP or something else is ideal for the variable levels of connectivity that Wireless Information Devices (WIDs) need to handle. Indeed the ability to use variable delivery mechanisms and perhaps conceal this selection process to the developer will enable applications to be quickly developed that overcome the inherent difficulties for delivery services to WIDs.

Standardization

SOAP is an open standard and already many open source implementations of both client side and server side software have been released. While there was initially some fear that it would be hijacked by one of the initial vendors behind it who would add proprietary features in order to gain dominance, this is unlikely to happen as the user community involved with SOAP is already mature enough to deal with this problem.

Standardization is very important in this area, as more services become available via the one protocol the more value supporting this protocol has. It is anticipated that supporting a non-SOAP method of service delivery may be akin although not as severe a problem to supporting a non-HTTP hypertext transport protocol instead of going for HTTP.

Remote Procedure Calls (RPC)

While not intended as a specific RPC engine, SOAP is already developing a standard for the encoding of requests, responses and faults. It may also encode existing application level protocol, an example could be SyncML's synchronization protocol, however the standard encoding for request, response and fault are likely to become dominant

Language Independent

Due to the existing availability of XML libraries for many languages and the very nature of SOAP, client software is either immediately available or can be provided quickly for many languages. This will ensure that developers writing software for WIDs can do it in their language of choice.

Flexible Transports

One obvious requirement for a fit-for-purpose Framework is its ability to use various transports in a flexible, optimised manner. Just as eg. current WAP architecture has separated the transport layer from the protocol, similar arrangement is needed for ServML. Several types of messaging are needed in order to cater for the extensible nature of the Framework.

Client to Client

Asynchronous

Majority of existing messaging is asynchronous in nature. Short Message Service (SMS), Enhanced Messaging Service (EMS), Bio Messaging (BIO) and Smart Messaging can all use GSM's signalling channel, which provides relatively slow but lightweight transport for messages required by the ServML Framework. Similarly, the store and forward mechanism used provides flexibility for the interaction. We see that SMS, EMS, BIO and Smart Messaging provide a good, functional transport solutions for ServML before Universal Mobile Telephony Standard (UMTS) and Multimedia Messaging Service (MMS) arrive.

Synchronous

Unstructured Supplementary Services Data (USSD), Wireless Access Protocol (WAP), Bluetooth (BT) and Infrared (IrDA) can all be used as transports for ServML. While USSD is functionally much closer to SMS and EMS than BT or IrDA, its session-oriented nature presents opportunities for more synchronous messaging. BT and IrDA on the other hand can, while limited in their current functionality, provide a user-friendly way for devices to exchange information when in close range from each other.

Client to Server

Just as important as providing separation of transport and protocol between two clients, it is between the client and the server. Using existing transports such as Circuit Switched Data (CSD) or WAP to access the services on the server side gives ServML a choice to route the transactions. Similarly, using standard IP formats such as MIME, SMTP and HTTP will enable compatibility with Internet Messaging systems.

SyncML

One of the most promising transports for ServML data is SyncML Sync protocol. It is an industry standard way of synchronising data between the server and the client, and is therefore natural candidate for carrying ServML payloads. SyncML Sync protocol is very suitable for transferring asynchronous data but if a more synchronous transport is needed the protocol is too heavyweight to set up and use. An investigation into how SOAP and SyncML could possibly co-exist is currently under way.

Best Fit-for-Purpose Messaging

ServML is designed in a way that allows independence from the transport mechanism. This is useful for two reasons:

As the transport mechanisms evolve and change they have less of an impact for ServML Services

ServML Services can pick and choose most appropriate transports for any given task

Isolating the payload by providing ServML wrappers is therefore an effective way to utilize various transport mechanisms in a flexible manner.

Sample Architecture Solution

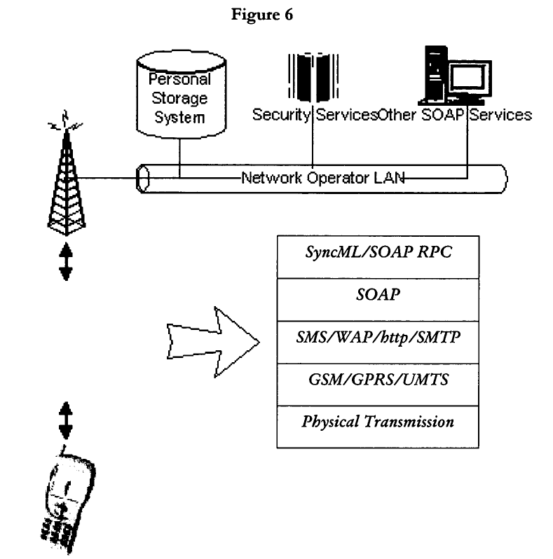

Based on the investigations we envisage that a ServML Framework solution is likely to be using some form of communications standard, probably SOAP, some form of Identification System and some form of Personal Storage System. These are likely to be the key building blocks of the ServML Framework. This would naturally imply that there is a requirement for SOAP interfaces to both of these core systems. So it is likely we will have a general architecture similar to FIG. 6.

Currently data is stored either on the user's hard disk or on the server's hard disk. As these are less than ideal for the WIDs, there is a need for a centralised information area. This is described as a Personal Storage System (PSS) and it is likely to continue the trend of modem file systems and be hierarchical in nature. However unlike current file systems it is likely to store information in the form of XML as opposed to data in the form of proprietary data formats.

We need a trust/reputation mechanism alongside an authentication service, this is likely to allow services such as the PSS and miscellaneous SOAP based services to authorize transactions. This Security Service (SS) is most likely to be linked to the Identification services already described. While similar in nature to the PSS it is important that any such system is independent from it, so that if vulnerabilities are discovered it can be upgraded independently of the PSS. To enable this upgrade both the PSS and the SS require APIs that are well defined.

SOAP is like to become the standard transport for a number of diverse services. These services are likely to be diverse in nature however most of them are likely to require the PSS and the SS parts already mentioned. Hence both the PSS and the SS should offer a SOAP interface which other SOAP services can make use of.

It is likely that there will be some form of world-wide directory service(s) with registration and resolution of general identities will start to appear soon. Such a directory service should be able to resolve to the Identification System for the ServML Framework, however the creation of such a system is outside the scope of this framework.

Keeping ServML Framework agnostic from the bearers is a key requirement, so that the solution can be deployed across geographical areas and therefore technologies.

Experimental Work

In an attempt to learn more about some possible technology solutions to the requirements set out in this document, experimental work was carried out

GSM Based Proof of Principle

A proof of principle study was carried out to discover how existing technologies, such as GSM, SMS and CSD could accommodate ServML type of activities. The setup included clients running modified version of Symbian OS Contacts, and Network side handling the storage, updating and notification.

The main finding from the study was that without establishing standardised ways of creating, accessing and transmitting information across, the system will not be reliable or fast enough to provide a satisfactory user experience. A recommendation was therefore made to both explore better mechanisms for managing the information, and possibly rely on the packet based transfers such as GPRS.

SOAP Based Proof of Principle

Extending on the GSM based proof of principle a further SOAP proof of principle was carried out utilising HTTP, TCP/IP and SOAP in order to develop a simple forums service. This forums service used SOAP over SMTP and a simulated mail delivery mechanism (that in turn used HTTP) to overcome some of the difficulties with the quality of service of wireless.

The parsing of the XML based SOAP protocol on the client side was not carried out with a full XML parser at this time, instead a simple regular expression engine was used, further work on alternatives to parsing and the use of compressed forms of XML are likely to be research topics in the future.

The main finding from the study was that with the use of simple API's wireless services could be delivered extremely quicklyAlso the flexibility of SOAP services on the server side of the architecture allowed for services to be developed extremely quickly in a matter of days instead of weeks. Such services are also attractive for developers as they can be used by a number of different devices, however it is important that developers have guidance on the constraints of creating services that will be applicable to the wireless platform.

Conclusion

Symbian stands along with many others at the start of the road towards what has been named 2^{nd} generation Internet, this new Internet will no doubt provide greater support for wireless services. Symbian is ideally positioned to develop some of the standards and API's for the client/server technologies that will enable the wireless facilities of this new Internet.

It would be pointless to create new technologies for this as there are already several key building blocks, such as SyncML and XML, and basic candidate technologies such as PKI and SOAP that can be used for the framework. Standards and best practices for the use of the technologies and the development of the “glue” to combine them are the challenges for Symbian. A modular distributed framework is required with generalised API's that can support other standards if they emerge later.

Wireless services are likely to be communication based, hence some of the services that provide Identification and Identity are likely to be key in these new generation of services. Also the market for such services is much less technology literate and so another key challenge is to deliver the technologies in a user-friendly way.

Section H

An illustration: How the ADS System Framework is Used in Making a Teleph ne Call

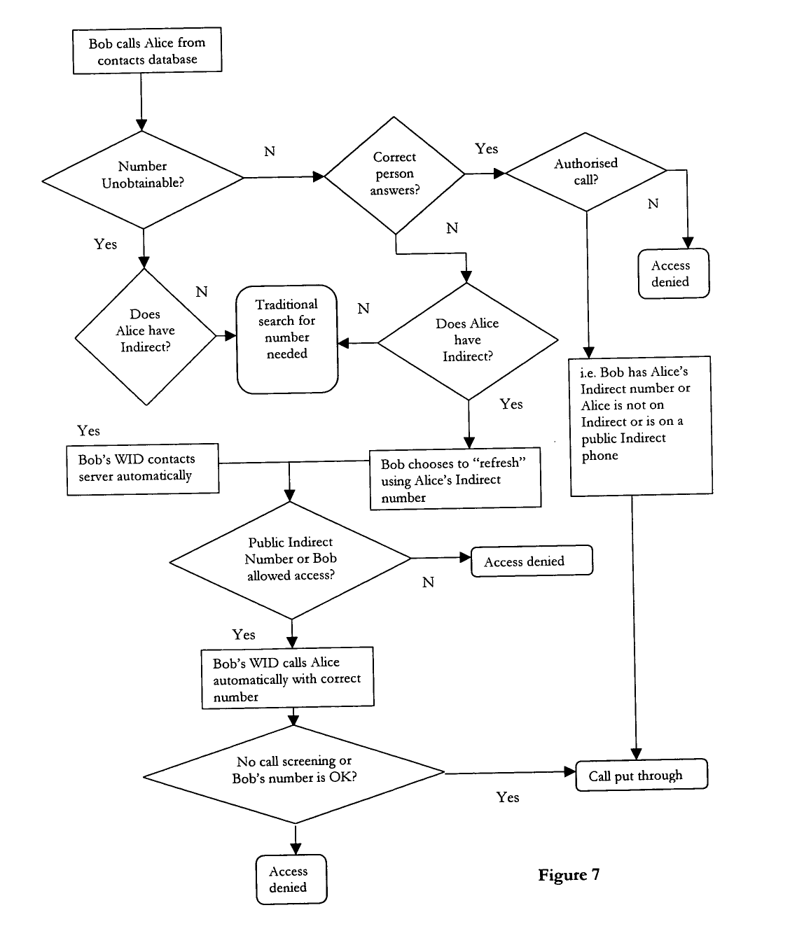

The ADS system enables Bob to reach Alice even when the telephone number for Alice is temporarily or permanently not applicable, so long as Bob has Alice's ADS Number. The approach is shown in FIG. 7, which is a flow chart showing the possible events associated with making a telephone call using the ADS system.

A brief walk through the flowchart follows:

1. Bob's ADS system mobile phone calls a phone number for Alice directly after looking it up in its local contacts database.

2. If the cached number for Alice is correct, and the call passes the access control (i.e. call-screening mechanism) described above, then the call is put through.

3. If the cached number rings the wrong person, then Bob might apologise and hang up the call (or the wrong person's device might automatically tell Bob's phone that Bob is not known, saving Bob from having to speak with someone he does not know). He must then manually choose to “refresh” the ADS Number of the person he is calling (i.e. go to the server and obtain up to date, replacement information). If he is calling a number with no associated ADS Number, he has to use traditional methods to trace Alice.

4. If the number is unobtainable, the ADS system phone automatically makes a data call to the ADS system server.

5. The ADS system server receives a data call from Bob's ADS system phone. (Where both Alice and Bob have separate servers, then the data call from Bob routes to Bob's server first, which in turn routes the data call to Alice's server). The data call includes the following data: (i) Alice's ADS Number, Ci) Bob's ADS Number and (ii) an information “password” which is unique to Alice. The server tries to find Alice's ADS Number. If it cannot be found, the server returns an error “invalid ADS Number”. If Alice's ADS Number exists, the server searches the database for the information “password”. If it does not find it, it returns only publicly available information to Bob. If the “password” is found, then Bob's ADS Number is put in Alice's contact list (see Table 2) in a group associated with the password. If Bob's ADS Number does not exist, he is encouraged to create one to enable him to pass Alice's call-screening. Bob's ADS Number is cached to pass to Alice's phone when it next accesses the server (or is sent immediately if Alice is addressable). The server looks up Alice's current telephone number, and gives Bob the number if Bob has the required access rights (e.g. depending on the group Bob has been placed in by Alice (e.g. friends, business etc.)) If Bob has no specific access rights, then he is returned just Alice's public information.

6. Assuming Bob is given an up to date number by the server, that number replaces the out of date number held locally on Bob's device. Bob's device then automatically calls the updated number for Alice it has received from the server. Conventional switched telephony or VoIP networks are used for this.

7. Alice's phone rings, and screens Bob's call, only allowing the call through if Bob's device is both authenticated (e.g. recognised as Bob's device by virtue of a unique and ideally secret feature of Bob's device, known to Alice's device) and also authorised (i.e. Alice is willing to speak with Bob; for example, she is on vacation and is allowing through only calls from friends, a class to which Bob has been allotted).

The ADS System: ADS Numbers

An ADS Number is the most prominent and public aspect of the ADS system. It is in one implementation an address on a web server—for example www.indirect.com/Alice. (Other less visible approaches are also possible). This address is in effect a pointer to entity specific data held on the web server, in this case, Alice's information. ADS Numbers can be included on printed business cards and handed it out at meetings, and included in vCards and beamed from one device to another. ADS Numbers can be any text or number string; multiple aliases are possible, all relating to a single root ADS Number.

In addition to the ADS Number, an entity can also hand out a piece of data that is usually restricted to entities in just one of that entities Groups. For example, Alice could hand out not only her ADS Number, but also her direct dial phone number. That information, although not persistent in the same way as an ADS Number, can fulfil a number of important roles: first, it can be used to reach Alice in the conventional way. Secondly, it can be used as the “password” described in the telephone call example at point C5 to allow a first time caller to be placed into an appropriate group.

Secti n I

An illustration: The ADS System Database

The database is at the heart of much of the ADS System's extensibility. Each piece of data on the server (the “i-server”) has an associated tag (or name) which defines its meaning. The tags (“i-tags”) live under a unique category name that is allocated by Symbian to ensure that the global namespace is not polluted.

The database is divided into a set of categories. Typically, each category is created and owned by a different application. Within each category, each piece of data has an associated tag and an associated list of groups (“i-Groups) allowed to access the data. The application owning the category is free to invent whatever tags it chooses, giving complete extensibility, although it may have to publish these to ensure interoperation with other services outside the framework. Any constraints of a particular device (e.g. quantity and formatting of incoming data) can be handled by the client based application, enabling the database to be generic.

The following table, Table 1, is an example application view of Alice's i-Data. This data is about Alice. Some information is entered by Alice (e.g. her name). Other information is entered automatically (e.g. location information from Bluetooth pods). A view of this database would be provided on Alice's mobile device to allow her to manage her data.

TABLE 1
Alice's iData

| Field/Attribute | Category | Details | i-Groups |
|---|---|---|---|
| First name | personal | Alice | all |
| Family name | personal | Edwards | all |
| Title | work | European Marketing | all |
| | | Manager | |
| Company Name | work | Wireless Information | all |
| | | Device gets R Us | |
| Company Address | work | 1 Science Park Rd, | all |
| | | London, N1 | |
| Company E-mail | work | alice.edwards@Wireless | business 1 |
| | | Information Device | |
| | | getsrus.com | |
| Company | work | 0207 200 2000 | all |
| switchboard | | | |
| Company Direct | work | 0207 200 2012 | business 1 |
| Mobile Phone | work | 0840 1234 567 | business |
| | | | 1, friends |
| Home Phone 1 | work | 0208 341 1234 | friends, |
| | | | family |
| Home Address | work | 25 The Gables, | family |
| | | Hampstead, London, | |
| | | NW3 | |
| My photo | photos | | friends |
| Childhood photo | photos | | family |
| Home note | notice | Sorry about dinner [symbol] | partner |
| Work note | notice | In a meeting with Tim | work 1 |
| | | till 7pm | |
| My mood now | mood | Very tired | all |
| Tel Call Subject | | “Dinner Tonight” | |
| Bluetooth | location | Bluetooth pods | |
| | | 1000-1020 | |
| | | . . . Sentinel room 2 . . . | |
| GPS | location | London W1, Seymour St. | partner |
| Hobby | preferences | Photography, travel | friends |
| Book | preferences | Maverick | friends |
| AlbumOfTheWeek | InstaPoll | | friends |

Note that although there are many i-Groups, there are only two overall dimensions to this information—public and private.

Public information (i-Group=“all”) is available to anyone with a web browser. It is what Alice would write on a business card (or a home version of the same). When Alice gives her ADS Number out at meetings and parties, she does not have to add a phone number or any piece of data giving access to one of her i-Groups (earlier referred to as a “password”). The advantage of not doing so is that the people she gives her card to will not end up in her contacts database (although those she does give private access to will end up there eventually, as described above). This is a good way to operate if Alice is providing a public service—perhaps Alice is a plumber or builder.

Some fields can contain multiple objects and can be thought of as container fields. For example, the Photos' field might contain all of Alice's many hundreds of personal photographs. The server than presents a table to Alice, showing thumbnails of all of the photographs and enabling Alice to allocate viewing rights to particular groups or individuals. Each photograph is allocated a unique number, allowing it to be identified. The unique number can be thought of as an anonymous tag, allowing Alice to restrict viewing rights of objects in a container field to appropriate groups or individuals. For example, say Alice only allows a particular photo of herself on the server to be seen by Bob; Bob's browser enquires of the server which photos he can view and is returned this special image; anyone else enquiring as to which images they can view is not shown this image. Appointment lists will also contain multiple entries and can also be thought of as containers. Allocating anonymous tags to each entry, with associated viewing (and possibly writing) rights is therefore also required.

As noted, sensitive information is only available to people in certain i-Groups; allowing Alice to control what data they see. There are two methods of making contacts into members of a particular i-Group. The first way is that whenever Alice wishes to, she can change the level of access of a current contact—perhaps promoting Bob from “business” to “friend”. Alice's device will report this to the server, and then Bob will be given this new information when he next contacts the server (or it will be pushed to his device if technology allows).

As described above, Alice can also hand out a piece of data to Bob that is usually restricted to people in just one of her i-Groups (say her direct dial phone number). Then the server will validate this information when Bob comes to use it together with Alice's ADS Number, and will add Bob's details to Alice's Universe (see Table 2 below). Bob's details will then be downloaded to Alice's mobile device when Alice comes to re-fresh her ADS system wireless information device, or may be pushed to Alice's wireless information device. Alice need not have to hand out additional data. For example, if Alice gives Bob her ADS number, then Bob can send Alice a message stating that he would like her contact details; Alice can then place Bob into the appropriate Group in her Universe on her local device; that device can then inform Alice's server, which in turn provides Bob's server with Alice's contact and other information appropriate to his group. Bob's server then tells Bob's device(s).

The ADS System also includes an entire contacts database, referred to as a ‘Universe’. It is the list of all the entities known to an entity and to whom access to more private data is to be given. Table 2 below is an example view of Alice's Universe, which shows how contacts are assigned to one or more i-Group, thus defining the level of access they get to Alice's data Alice can enter this data herself, importing the data from her current PDA or PIM. But the list also auto-updates: when someone who has Alice's ADS Number first calls Alice or uses Alice's ADS Number to read her information, then that person's contact details are automatically placed into Alice's Universe, as explained at above.

TABLE 2
ALICES UNIVERSE

| NAME | DETAILS | i-GROUP |
|---|---|---|
| Aardvark plumbers | Number, email, address etc . . . | contractors |
| Bently, John | Number, email, address etc . . . | friend |
| Coppermill Corp | Number, email, address etc . . . | contractors |
| Davies, Charles | Number, email, address etc . . . | work 1 |
| Entwistle, Peter | Number, email, address etc . . . | partner, friend |
| Greenfield Ventures | Number, email, address etc . . . | business 1 |

When one of the people in the list above looks at Alice's ADS Number, (using an application on their ADS system wireless information devices), they see a view onto Alice's personal data that is defined by Alice. For example, someone in the business 1 group might see the Table 3 information in their contacts application:

TABLE 3

| | |
|---|---|
| Name | Ms Alice Edwards |
| Title | European Marketing Manager |
| Company | Wireless Information Device gets R Us |
| ADS Number | urls.co.uk/1238947532345235 |
| Last verified | 7^{th} July 2000 |
| e-mail | alice.edwards@Wireless Information Device |
| | getsrus.com |
| Work phone 1 | 0207 200 2000 |
| Work phone 2 | 0207 200 2012 |
| Mobile | 0840 1234 567 |
| Address | 1 The Science Park, London, N1 9PQ |
| Other info | Met her at meeting with Tom Jones, August 2000. |

All of the fields except the ‘Other Info’ field, have come from the i-Server and cannot be altered locally. The ‘Other Info’ field is provided for the local user to keep his personal notes on each contact. This field is not updated when the contact is refreshed.

The user interface of the wireless information device will denote in some way the freshness of the data (whether it has recently been updated from the i-Server). For example, a fresh green icon could be used to denote freshness, gradually turner brown as the associated data ages. A ‘Last Verified’ date field could also be used, as shown in Table 3.

Section J

The ADS System: Applications

A key strength of the ADS system is the very large range of new functions and applications it supports. Some of these are listed below. The list is not exhaustive and also references for convenience many of the features discussed earlier in this specification.

Some of these functions and applications can be implemented today using proprietary technologies. However, by using the ADS system framework with its standard and extensible XML (or similar) tags, the applications can now be constructed simply and in a compatible way. New functions and applications can be sent over the air to ADS wireless information devices, making the roll-out of these new functions and applications fast and efficient The net result is that developers can write applications using standard tools and their customers can be confident that their applications can be supported, maintained and extended by others. There is greater potential for economies of scale and reuse of system components than would otherwise be the case.

TABLE 4

| | New communications functionality |
|---|---|
| Short title | Description |
| Auto-entering | Auto-entering of a contact's details into a person's |
| address book | ‘Universe’ of contacts stored on the i-server (and |
| | optionally cached on wireless information devices) when |
| | that contact first calls that person, so the person doesn't |
| | need to enter the contact details manually. Bob, a first |
| | time caller to Alice, needs to provide at a minimum |
| | Alice's ADS Number and his own ADS Number for his |
| | details to automatically be provided to Alice. Alice's |
| | contact list can grow automatically as new ADS system |
| | users call her. |
| Auto-updating | Auto-updating of a complete contacts list held on the |
| address book | I-server, so a person, Bob, doesn't need to enter or |
| | manually update it or risk losing touch, in which the |
| | auto-updating is initiated by the owner of the contacts |
| | list. All the owner, Bob, needs is the ADS Numbers of |
| | the entities whose details he wishes to up date. Where |
| | those entities already know Bob (i.e. Bob is in their |
| | Universe), then the data Bob is entitled to receive is |
| | already defined. If Bob is not yet in their Universe, then |
| | Bob needs to provide an additional password, which |
| | defines the level of information he is entitled to or else |
| | enter into a dialogue with Alice with the aim of Alice |
| | placing Bob into her Universe in a given group. |
| Job title anchor | People in a ‘Universe’ who are interested in a contact |
| | especially because of his or her job title can notify the |
| | I-server of that fact. If a new holder of that job title |
| | arises, then those people are informed automatically by |
| | the I-server and the new job holder automatically gets |
| | placed into their Universe and they automatically get |
| | placed into the new job holder's universe. |
| Call privacy | Access control, so that only people in a person's address |
| | book stored on the i-server (i.e. Universe) can get |
| | through to that person. |
| | Or only people who are both in the Universe and also are |
| | in a defined category in that person's Universe can get |
| | through (e.g. ‘friends’ only). |
| Call privacy | Access control, with callers able to override a do-not |
| override | interrupt facility in certain circumstances defined by the |
| | caller. Can be facilitated by the called party Alice posting |
| | a description of her current activity which can be read by |
| | a caller, Bob, who then assess whether he should |
| | interrupt. That data transfer may run directly between |
| | Bob and Alice's phones and not involve a trip to the |
| | server. |
| Groups | Group ADS Numbers: A family or organisation can |
| | acquire a Group ADS Numbers—changes to the Group |
| | ADS Numbers are automatically propagated to the |
| | wireless information devices of all group members. |
| | A single push transmission can reach many group |
| | members, which is efficient. |
| e-mail | The server automatically re-directs e-mails to a work |
| management | colleague when the initial addressee is on holiday and |
| | automatically copies incoming e-mails to appropriate |
| | work colleagues even though not addressed to them by |
| | the sender. Format conversion may also take place: if |
| | an e-mail is for Alice, but Alice is only contactable by |
| | voice, then the server can convert the e-mail into a |
| | voice attachment. |
| Job profile | Recruitment services with job opportunities can be |
| | matched by the I-server to Alice's skills/profile as |
| | defined in her database. |
| Chat profiling | The chat application will come with a set of i-Tags for |
| | such items as hobbies, interests, tastes in music and so |
| | on. The user will complete these locally, and then use the |
| | chat application to contact the i-Server and discover what |
| | groups they are suitable to join today. |
| Appointments | On the iPhone, appointments are not local; they are |
| and Invitations | pointers to appointment data kept on the originator's |
| | server. One person will create the appointment, usually |
| | giving the other person authority to change it too. As the |
| | appointment is changed, both agendas see the changes |
| | instantly. (Though copies may be cached, like contact |
| | details, for use when out of coverage.) |
| | This method may be used to make invitations to many |
| | friends. The person hosting the event makes an |
| | “invitation” calendar entry, which is sent to the i-Server. |
| | The i-Server then sends the calendar entry to the invitees, |
| | and their calendar application may then either accept or |
| | reject the invitation—returning a changed (or refused) |
| | appointment to the server as appropriate. After some |
| | negotiation (in an agreed protocol between the clients, |
| | the server acts merely as a message passing entity) the |
| | date and time of the event is agreed |
| Opinion polls | Opinion polls can be conducted efficiently and on-line— |
| | individuals meeting defined criteria (e.g. age, income |
| | etc.) can be readily identified and contacted via their |
| | wireless information devices for them to post their poll |
| | answers to the i-server. |
| Viral marketing | Word-of mouth marketing is possible through people |
| | posting favourite films etc. onto the I-server with public |
| | viewing rights. |
| People tracking | The I-server is up-dated with the location of a person. |
| | That location data can be obtained via a GPS wireless |
| | information device, which transmits location information |
| | to the i-server, enabling authorised people to track the |
| | location of the GPS wireless information device by |
| | polling the server. Alternatively, a Bluetooth pod could |
| | transmit information to the person's wireless information |
| | device, which in turn passes it up to the I-server. Would |
| | be useful for tracking children and pets. |
| Personal view | Camera in the wireless information device, posting |
| | images to the I-server |
| Data push | Third parties can push information to the I-server, which |
| | can be passed up to the wireless information device as |
| | appropriate. |
| Portholes | Portholes: users define parts of a web page they're |
| | interested in and the I-server downloads these and stores |
| | them; allowing a user to rapidly and reliably view them |
| | by going to the I-server. |
| | Hence, the data on the server does not necessarily have to |
| | come from a client device. It can be provided by a |
| | content provider, and the i-Frame provides an easily |
| | extensible framework for providing data in a device |
| | independent way. For example, a service provider wishes |
| | to provide on-the-minute train service information |
| | (whether the train is on-time or delayed and so on). |
| | Typically, the people using this service are only |
| | interested in three or four services—those that they |
| | habitually take to and from work. So, they embed a few |
| | “portholes” in an page of the jotter (or other EPOC |
| | application). The porthole is an ADS Number |
| | (referencing a page on an html server on the Internet) |
| | plus the relevant i-Tag, which chooses one item of data |
| | from that page. When the user refreshes their Jotter page, |
| | the i-Server is contacted, and the latest data is displayed |
| | in the portholes. |
| | Potentially, an update frequency could be associated with |
| | the data, and the i-Server could send it out periodically. |
| Medical data | Medical devices can post e.g. heart ECGs to the i-server |
| | (either directly if it has comms capability or via a |
| | wireless information device). Doctors can view the data |
| | from the server. The server can interpret and analyse |
| | the data (rather than merely provide ‘dumb’ look-ups) |
| | and issue alarms if needed. |
| Banking | The server includes the user's bank/credit/charge card |
| | details. If the server can interface to the bank/credit card |
| | clearing system, then any merchant that would accept a |
| | bank card/credit/charge card will accept a payment from |
| | a wireless information device, assuming it has the right |
| | POS. |
| e-purse | The server includes an e-cash balance, which the user can |
| | spend using his wireless information device. |
| New buddy | Compatible personal profiles stored on the I-server can |
| finder | be readily identified and the corresponding individuals |
| | alerted to their mutual presence at a party, club etc. |
| Old buddy | Wireless information device alerts Bob when a contact |
| finder | happens to be within a defined proximity (e.g. Bob and |
| | Alice are both in the same foreign city and didn't know |
| | it). |
| Lost buddy | Finding old friends—through posting a personal |
| finder | biography in a public part of the I-server which is |
| | searchable, enabling lost friends to find one. |
| E-mail | When an e-mail is sent, attachments are kept at the |
| attachments | server, only a tag is sent to the recipient Bob (possibly |
| | containing a small abstract of the attachment), who can |
| | then download it only if he thinks it's necessary, and |
| | can also do so only when it is convenient. |
| | Attachments can be set so that they cannot be forwarded |
| | by the recipient or that the server tracked to whom any |
| | forwarding is done. |
| Data freshness | A visual indication of the freshness of Alice's contact |
| | information can be shown on Bob's wireless information |
| | device, indicating how fresh that cached data is. An icon |
| | could be used; selecting that icon could allow Bob to |
| | automatically re-fresh the data. |
| Bluetooth | Communicating information from a Bluetooth pod to the |
| device posting | phone, using the wireless information device as an |
| to the I-server | information conduit to update the I-server, with only |
| | defined categories of person (defined by the phone |
| | owner) to access that information |
| | Bluetooth heart monitor communicates to a wireless |
| | information device which sends data to the I-server— |
| | then doctors can access a person's current heart beat and |
| | other vital signs etc. for remote diagnostics by accessing |
| | the server; unusual patterns can automatically trigger a |
| | call to a doctor |
| | Location finding using Bluetooth pods informing phones |
| | of their location and the phones then sending that |
| | information to the I-server. Allows people to be tracked. |
| | Any Bluetooth device can therefore become an Internet |
| | device using ADS |
| Access control | Using an ADS system enabled device as an access |
| | control key |
| | Users can be asked to answer questions requiring |
| | knowledge of the contents of their personal database |
| | Bluetooth lock handshakes with wireless information |
| | device and then asks the I-server what access privileges |
| | the person has, unlocking if appropriate |
| 6 Degrees | The I-server works out if a caller who is not in your |
| | contacts, is linked to you by being known to a contact |
| | of yours (or a contact of a contact). The degrees of |
| | separation could be displayed. |
| PGP | Public keys are stored on the I-server. |
| Call screening | Phone rings only after indirect numbers are exchanged |
| Over-writing | Universe originally entered by Alice (e.g. derived from |
| legacy data | Alice's PDA) may have defects (mis-spellings, be out of |
| | date etc.). When data derived from the I-server (and |
| | which has been verified from its source) comes in it can |
| | replace the data on her Universe. Alice can also choose |
| | to preserve old data and not have it over-written. |
| Pre-Flight | Posting current activity or mood status (e.g. ‘Don't |
| Information | disturb’, ‘In a meeting’ etc.) to the i-server, the status |
| | being accessible to others with i-phones and appropriate |
| | access rights (i.e. belong to a category defined by the |
| | individual as being allowed to see the ‘mood badge’). |
| | Can influence and inform a person making an outgoing |
| | call: can be used by a caller to assess the mood/context |
| | of the person to be called, for example enabling the caller |
| | to override a ‘do not disturb—meeting with Joe’ message |
| | posted by Alice if Bob feels comfortable in interrupting a |
| | meeting between Alice and Joe (‘intelligent interruption’) |
| | Can influence and inform a person receiving an incoming |
| | call: can be used by a call recipient to assess the mood/ |
| | context of the caller. |
| | Alerts when the activity/status changes are possible: |
| | (‘Call Helen when she's off the phone’; ‘Alert me when |
| | Harry is in the office’) |
| Fitness tracking | A device such as a heart monitor or CO2 monitor etc. |
| | could record and transmit real lime fitness data to the |
| | ADS server; another device could access this data from |
| | the server for real time or subsequent analysis and |
| | display. |
| Vehicle | Sensors on a vehicle transmit telemetry data to the |
| telemetry | I-server, allowing the organisation analysing the data |
| | to notify the car owner of problems in a timely fashion |
| | for repair or servicing. |

[image]

[image]

[image]

[image]

[image]

[image]

1. A method of enabling a wireless information device to access data from several data services providers in which the method comprises the step of the device using an extensible, dynamic framework which handles data passing to and from several applications resident on the device, the framework being shared by each of the applications resident on the device and also being shared by each of the data services providers.

2. The method of claim 1 in which the framework comprises APIs from several applications resident on the wireless information device to data services components also resident on the wireless information device and which allow each application to obtain and display data provided by commercial data service providers.

3. The method of claim 2 in which the APIs are standardised APIs which share common elements.

4. The method of claim 2 in which a data services component can provide new functionality to more than one application resident on the wireless information device.

5. The method of claim 3 in which the APIs are extensible, with extensions conforming to a common standard so that new functions offered by a component are defined by certain new APIs and these APIs are re-used whenever the same new functionality has to be offered by a different application.

6. The method of claim 2 in which data sent from a commercial data service provider is automatically displayable in one or more applications on the wireless information device.

7. The method of claim 6 in which the applications on the wireless information device which can automatically display the data sent from a commercial data service provider are selected from the following group of applications:
(a) a calendar application
(b) a contacts application
(c) a location application
(d) a finance/payment application

8. The method of claim 2 in which the data handled by the data services components are objects.

9. The method of claim 8 in which the objects conform to or are extensions of the Smart Message standard.

10. The method of claim 8 in which the objects are signed to enable authentication to occur.

11. The method of claim 1 in which all directory/contacts type applications are grouped together and a single search can be conducted across all directory/contacts type applications.

12. The method of claim 1 in which a search or other data service requests uses additional information derived from data on the device to provide additional search or request criteria.

13. The method of claim 2 in which new data services components can be dynamically added.

14. The method of claim 13 in which dynamic addition occurs as the wireless information device changes location.

15. The method of claim 1, in which the framework is defined by a schema.

16. A method of enabling a wireless information device to access data from several data service providers in which the method comprises the step of each of several applications resident on the device using at least in part a common, extensible schema which:
(a) defines objects from each of the data service providers; and
(b) permits each data service provider to define a new object with additional attributes, in which the new object can be used by any such application on the device to the extent that the attributes of the new object are recognisable by that application.

17. The method of claim 16 in which an object is sent by a commercial data service provider and interfaces to client resident applications using standardised APIs.

18. A wireless information device programmed to access data from a data service provider by using the method of any of claims 1-17.

19. Software for a wireless information device which, when running on the device enables the device to access data from a data service provider by using the method of any of claims 1-17.

20. A method of generating revenues relating to the use of an application on a wireless information device, in which revenue is generated from a user when that user operates a wireless information device to perform the method of any of claims 1-17.
